(19) United States
(12) Patent Application Publication
(10) Pub. No.: US 2026/0197830 A1
(43) Pub. Date: Jul. 9, 2026

(54) TERMINAL AND WIRELESS COMMUNICATION METHOD

(71) Applicant: NTT DOCOMO, INC., Tokyo (JP)

(72) Inventors: Yuki Takahashi, Tokyo (JP); Satoshi Nagata, Tokyo (JP); Qiping Pi, Beijing (CN); jing Wang, Beijing (CN); Lan Chen, Beijing (CN)

(73) Assignee: NTT DOCOMO, INC., Tokyo (JP)

(21) Appl. No.: 19/128,033

(22) PCT Filed: Nov. 15, 2023
(86) PCT No.: PCT/JP2023/041075

§ 371 Date: May 7, 2025

(30) Foreign Application Priority Data
Nov. 17, 2022 (JP) 2022-184489

(51) Int. Cl. H04W 72/21

(52) U.S. Cl. CPC H04W 72/21

(57) ABSTRACT

This terminal includes a control unit determining uplink control information including information related to the number and/or duration of transmission opportunities for uplink signals unused, and a transmission unit transmitting the uplink control information.

### TECHNICAL FIELD

The present disclosure relates to a terminal and a radio communication method.

### BACKGROUND ART

Long Term Evolution (LTE) has been specified for achieving a higher data rate, lower delay, and the like in a Universal Mobile Telecommunication System (UMTS) network. Future systems of LTE have also been studied for achieving a broader bandwidth and a higher speed based on LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

In 5G, various wireless technologies and network architectures are being considered to meet the requirement of reducing the latency in the radio section to 1 ms or less while achieving a throughput equal to or greater than 10 Gbps (e.g., Non-Patent Literature (hereinafter, referred to as NPL) 1).

In NR, the configuration of a Configured Grant Physical Uplink Shared Channel (CG PUSCH) is defined in Release 16 (e.g., NPL 2). The CG PUSCH includes Type 1 CG PUSCH and Type 2 CG PUSCH.

The transmission parameters for Type 1 CG PUSCH are provided by “configuredGrantConfig,” “pusch-Config,” and “rrc-ConfiguredUplinkGrant.” The activation/deactivation of Type 1 CG PUSCH depends on the RRC configuration and does not depend on Downlink Control Information (DCI).

Transmission parameters of Type 2 CG PUSCH are provided by “configuredGrantConfig,” “pusch-Config,” and “activation DCI.” The activation/deactivation of Type 2 CG PUSCH depends on the RRC configuration and DCI. One DCI can activate one CG PUSCH and can deactivate a plurality of CG PUSCHs.

Additionally, in NR, the configuration of a Semi-Persistent Scheduling Downlink Shared Channel (SPS PDSCH) is defined in Release 16 (e.g., NPL 2). The transmission parameters of SPS PDSCH are provided by “sps-Config” and “activation DCI.” The activation/deactivation of SPS PDSCH depends on DCI.

In NR, various technologies related to methods called Ultra-Reliable and Low Latency Communications (URLLC) and Industrial Internet of Things (IIOT) are being considered in Release 17.

In Release 17, considerations are being made for Extended Reality (XR), including Virtual Reality (VR) and Mixed Reality (MX), and the XR scenarios, requirements, Key Performance Indicators (KPI), and evaluation methods for XR have been studied. The target requirements for XR are to consider aspects such as capacity, latency (delay), mobility, and energy efficiency.

Additionally, at the RAN1 #111 meeting, it was agreed to support CG enhancement (extension) for XR in Release 18. Specifically, it was agreed to support dynamic indication of one or more unused CG PUSCH (transmission) occasions based on Uplink Control Information (UCI) (e.g., CG-UCI or new UCI) by a terminal, and to support multiple CG PUSCH occasions within the duration or period of a single CG PUSCH configuration.

### CITATION LIST

### Non-Patent Literature

### NPL 1

3GPP TS38.213 V16.3.0 (2020-09)

### NPL 2

3GPP TS38.331 V16.2.0 (2020-09)

### SUMMARY OF INVENTION

There is room for consideration regarding the reporting of HARQ-ACKs for SPS PDSCHs in large-capacity communications such as XR.

One aspect of the present disclosure is to provide a terminal and a radio communication method that each appropriately report HARQ-ACKs for SPS PDSCHs suitable for large-capacity communication.

### Solution to Problem

A terminal according to an aspect of the present disclosure includes: a control section that determines uplink control information including information on a number of unused uplink signal transmission occasions and/or a time width of at least one of the unused uplink signal transmission occasions; and a transmission section that transmits the uplink control information.

### BRIEF DESCRIPTION OF DRAWINGS

FIG. 1 illustrates an example of dual connectivity (DC);

FIG. 2 illustrates an example of PUCCH carrier switching;

FIG. 3 is a diagram illustrating an overview of Type 1 HARQ-ACK CB;

FIG. 4 is a diagram illustrating an overview of Type 2 HARQ-ACK CB;

FIG. 5 is a diagram illustrating an exemplary generation of Type 1 HARQ-ACK CB;

FIG. 6 is another diagram illustrating the exemplary generation of Type 1 HARQ-ACK CB;

FIG. 7 is still another diagram illustrating the exemplary generation of Type 1 HARQ-ACK CB;

FIG. 8 is a diagram illustrating an exemplary determination of candidate PDSCH reception occasions in Step A-2;

FIG. 9 is a diagram illustrating an example of HARQ-ACK ordering in Type 1 HARQ-ACK CB for SPS PDSCH;

FIG. 10 is a diagram illustrating an example of CG PUSCH;

FIG. 11 is a diagram illustrating an example of SPS PDSCH;

FIG. 12 is a diagram illustrating an example of TDRA configuration;

FIG. 13 illustrates examples of multiple SLIVs in the TDRA table;

FIG. 14 is a diagram illustrating an example of Alt.1-1;

FIG. 15 is a diagram illustrating an example of Alt.1-2A;

FIG. 16 is a diagram illustrating an example of Alt.1-2B-1;

FIG. 17 is a diagram illustrating an example of Alt.1-2B-2;

FIG. 18 is a diagram illustrating an example of Alt.1-2B-3;

FIG. 19 is a diagram illustrating an example of Alt.2-1;

FIG. 20 is a diagram illustrating an example of Alt.2-2;

FIG. 21 is a diagram illustrating an example of HARQ-ACK ordering in Type 1 HARQ-ACK CB for multiple PDSCHs;

FIG. 22 is a diagram illustrating exemplary candidate PDSCH reception occasions;

FIG. 23 is a diagram illustrating an exemplary enhanced PDSCH slot set;

FIG. 24 is a diagram illustrating an exemplary SLIV extension;

FIG. 25 is another diagram illustrating the exemplary SLIV extension;

FIG. 26 is a diagram illustrating an example of each alternation of Option 1 of Proposal 8;

FIG. 27 is a block diagram illustrating examples of variations for Option 1 of Proposal 8;

FIG. 28 is a block diagram illustrating an exemplary configuration of a base station according to the present embodiment;

FIG. 29 is a block diagram illustrating an exemplary configuration of a terminal according to the present embodiment;

FIG. 30 is a diagram illustrating an exemplary hardware configuration of a base station and a terminal according to an embodiment of the present disclosure; and

FIG. 31 illustrates an exemplary configuration of a vehicle according to an embodiment of the present invention.

### DESCRIPTION OF EMBODIMENTS

Hereinafter, an embodiment according to an aspect of the present disclosure will be described with reference to the drawings. In URLLC, enhancements to the feedback function of a terminal for Hybrid Automatic Repeat request-Acknowledgement (HARQ-ACK) are being considered. The HARQ-ACK is an example of information on a confirmation response (e.g., acknowledgement) to data received by the terminal. With respect to these study matters for URLLC, supporting dynamic and semi-static PUCCH carrier switching was agreed. Note that, the PUCCH carrier switching may be called by other names such as control-information-transmitting carrier switching.

The PUCCH carrier switching is a technology to be applied in a case where a base station performs communication via a plurality of cells. Hereinafter, dual connectivity and PUCCH carrier switching, which are examples of communication via a plurality of cells, will be described.

### <Dual Connectivity>

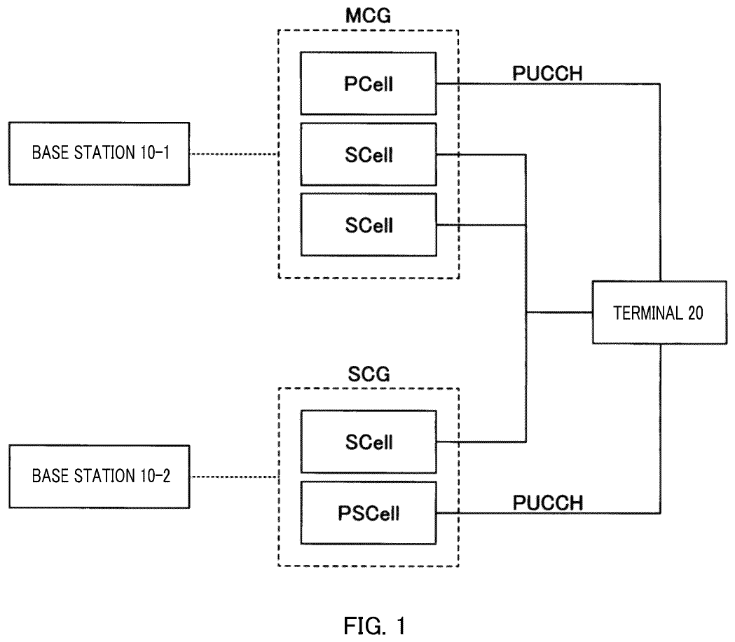

FIG. 1 illustrates an example of dual connectivity (DC). In the example of FIG. 1, base station 10-1 may be a Master Node (MN), and base station 10-2 may be a Secondary Node (SN). In DC, carriers between different base stations are bundled together as illustrated in the example of FIG. 1.

In the example of FIG. 1, base station 10-1 communicates with terminal 20 via a primary cell (Pcell) and secondary cells (Scells). In the example of FIG. 1, terminal 20 has established an RRC connection with base station 10-1.

In DC, a delay in communication between base stations 10-1 and 10-2 may occur, which makes it difficult to indicate, to base station 10-2, uplink control information (e.g., Uplink Control Information (UCI)) received in the Pcell of base station 10-1 via a backhaul link (e.g., wired or wireless link connecting base stations 10-1 and 10-2) to reflect the uplink control information in scheduling of an Scell under base station 10-2. Then, in the DC, one carrier under base station 10-2 may be configured as a Primary Scell (PScell) in addition to the Pcell of base station 10-1, and PUCCH transmission may be supported by the PScell. In this case, terminal 20 transmits UCI to base station 10-2 via the PScell.

In the example of FIG. 1, terminal 20 configures Scells for base station 10-1 in addition to the Pcell. Furthermore, terminal 20 configures an Scell for base station 10-2 in addition to the PScell. Terminal 20 transmits UCI of each carrier under base station 10-1 on the PUCCH in the Pcell. Furthermore, terminal 20 transmits UCI of each carrier under base station 10-2 on the PUCCH in the PScell. In the example of FIG. 1, the cell group (CG) under base station 10-1 may be referred to as a Master Cell-Group (MCG), and the cell group under base station 10-2 may be referred to as a Secondary Cell-Group (SCG).

In a case where DC is performed, terminal 20 may transmit PUCCH via a Pcell, PScell, and/or PUCCH-Scell. Generally, it is not assumed that terminal 20 transmits PUCCH via an Scell other than the Pcell, PScell, and PUCCH-Scell.

### <PUCCH Carrier Switching>

PUCCH carrier switching has been studied as a method for reducing latency in HARQ-ACK feedback in a Time Division Duplex (TDD) scheme.

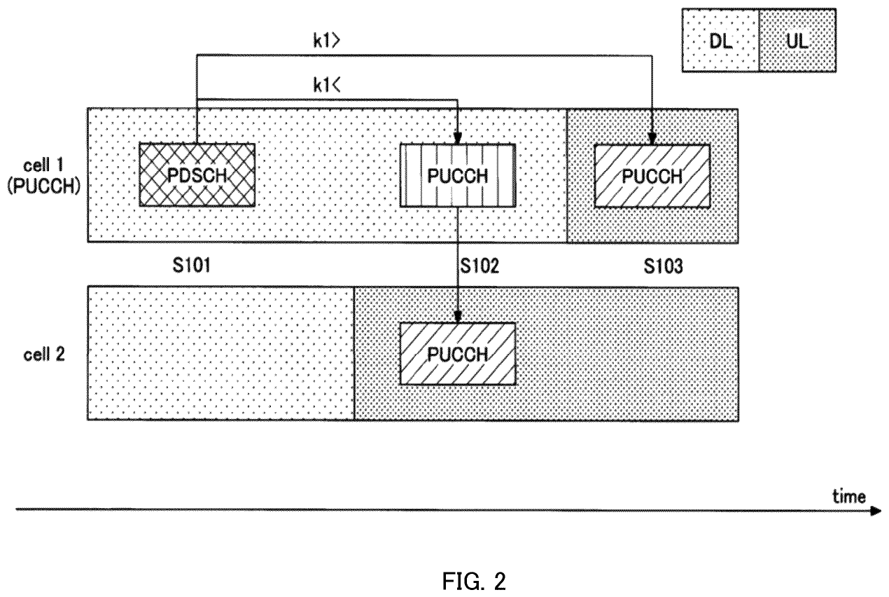

FIG. 2 illustrates an example of PUCCH carrier switching. In the example of FIG. 2, a base station and a terminal communicate with each other via cells 1 and 2. In the example of FIG. 2, cell 1 is a Pcell and cell 2 is an Scell. Furthermore, the example of FIG. 2 illustrates a downlink (DL) slot and an uplink (UL) slot in each cell.

In the example of FIG. 2, the terminal receives data (receives a Physical Downlink shared Channel (PDSCH)) at a timing of S101. The terminal attempts to transmit an HARQ-ACK for the data received at S101 at a timing of S102, but the slot of cell 1 at the timing of S102 is a downlink (DL) slot. Thus, in a case where the terminal transmits an HARQ-ACK in cell 1, the terminal holds the HARQ-ACK transmission until a transmission timing of PUCCH in an uplink (UL) slot (e.g., timing of S103 in FIG. 2), so that latency in HARQ-ACK transmission increases. Note that a PUCCH transmission timing in an uplink (UL) slot may be referred to as a PUCCH transmission occasion.

In the example of FIG. 2, the slot of cell 2 at the timing of S102 is a UL slot. In the example of FIG. 2, the latency in HARQ-ACK transmission can be reduced if the terminal can transmit an HARQ-ACK for the data received at S101 on the PUCCH transmission occasion at the timing of S102 in cell 2. In URLLC, low latency in a radio section is especially required. Accordingly, in 3GPP, PUCCH carrier switching in which a terminal switches between carriers that perform PUCCH transmission has been studied as an extension of URLLC technology.

Note that, in the following embodiment, “the same timing” may be completely the same timing or may represent that all or some of time resources (e.g., one or a plurality of symbol(s) (which may also be resources in time units shorter than a symbol) are the same or overlap.

The PUCCH carrier switching may also represent that, in a case where a terminal attempts to perform PUCCH transmission at a specific transmission timing of a Pcell (which may be PScell or PUCCH-Scell), since the slot of the Pcell (which may be PScell or PUCCH-Scell) at the specific transmission timing is a DL slot, the terminal switches a cell for performing PUCCH transmission from the Pcell (which may be PScell or PUCCH-Scell) to an Scell (which is Scell other than PScell in the case of PScell, and is an Scell other than PUCCH-Scell in the case of PUCCH-Scell) of one or a plurality of Scell(s) in which a slot at the same timing as the specific transmission timing is a UL slot. Note that, in the example of the present invention, the unit of the specific transmission timing is not limited to a slot. For example, the specific transmission timing may be a timing in units of subframes or in units of symbols.

Two methods have been studied for achieving PUCCH carrier switching. The first method is a method in which a base station dynamically indicates a carrier for performing PUCCH transmission to a terminal. The second method is a method in which a base station semi-statically configures a carrier for performing PUCCH transmission for a terminal. Note that, in an example described below, “PUCCH transmission” and “transmitting PUCCH” may refer to transmission of uplink control information via PUCCH.

The terminal may indicate, to the base station, terminal capability information (UE capability) that defines information on capability of the terminal related to the PUCCH transmission.

For example, information indicating whether the terminal supports switching between configurations related to transmission of control information may be defined as the UE capability of the terminal. Switching between configurations related to transmission of control information may be, for example, switching between resources (e.g., carriers or cells) used for transmitting control information. Switching between resources used for transmitting control information may also be referred to as “PUCCH carrier switching.” Furthermore, information indicating application of dynamic PUCCH carrier switching and/or semi-static PUCCH carrier switching may be defined as the UE capability of the terminal.

The configuration operation of the semi-static PUCCH carrier switching may be based on RRC by which a PUCCH cell timing pattern is configured for a PUCCH cell to which semi-static PUCCH carrier switching is applied. Further, the configuration operation of the semi-static PUCCH carrier switching may be supported between cells with different numerologies.

In the PUCCH carrier switching, PUCCH resources may be configured per Uplink Bandwidth Part (UL BWP) (e.g., per candidate cell and per UL BWP of the candidate cell).

In the case of PUCCH carrier switching based on dynamic indication of control information, a K1 value (offset) from a PDSCH to an HARQ-ACK may be interpreted based on the numerology of a target PUCCH cell to be dynamically indicated. Note that, the control information may be control information for PUCCH scheduling, such as Downlink Control Information (DCI). Furthermore, the numerology may be regarded as a slot or a Subcarrier Spacing (SCS).

In URLLC, enhancement of HARQ-ACK Codebook (HARQ-ACK CB) feedback by a terminal has been studied. The following are overviews of a Type 1 HARQ-ACK CB and a Type 2 HARQ-ACK CB (for details, see NPL 1).

Note that a Type 1 HARQ-ACK CB may also be referred to as a semi-static HARQ-ACK CB. A Type 2 HARQ-ACK CB may also be referred to as a dynamic HARQ-ACK CB. The terminal may be instructed on whether to apply Type 1 HARQ-ACK CB or Type 2 HARQ-ACK CB, for example, by higher layer signaling such as RRC.

### <Type-1 HARQ-ACK CB>

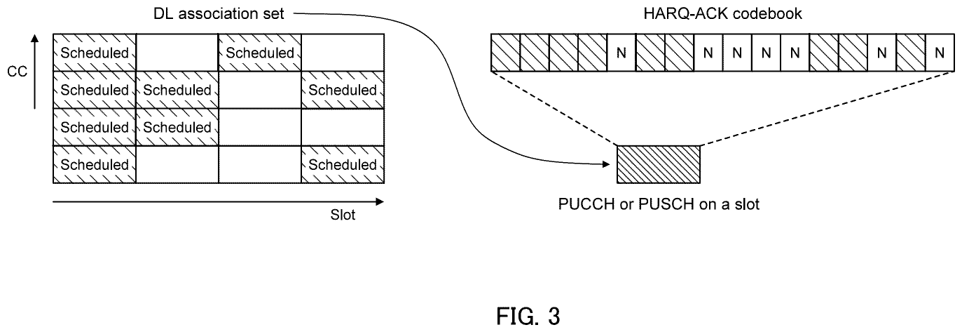

FIG. 3 is a diagram illustrating the overview of the Type-1 HARQ-ACK CB. The terms “scheduled” illustrated in FIG. 3 each represent, for example, a slot scheduled by DCI. The term CC represents a Component Carrier.

In the Type-1 HARQ-ACK CB, the terminal generates HARQ-ACK bits for PDSCH regardless of whether a scheduled slot (PDSCH) is present. For example, as illustrated in the “HARQ-ACK codebook” in FIG. 3, the terminal may configure NACKs for unscheduled PDSCHs.

### <Type-2 HARQ-ACK CB>

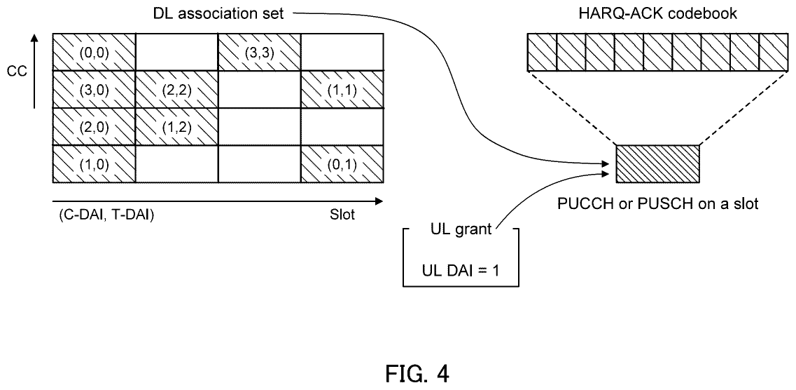

FIG. 4 is a diagram illustrating the overview of the Type-2 HARQ-ACK CB. The coordinates (x, y) illustrated in FIG. 4 each represent, for example, a slot scheduled by DCI. The x corresponds to a C-DAI value and the y corresponds to a T-DAI value. The DAI is an abbreviation for a Downlink assignment index. The DAI represents, for example, assignment of a scheduled PDSCH for which an HARQ-ACK is bundled to an HARQ-ACK CB.

In the Type-2 HARQ-ACK CB, the terminal generates HARQ-ACK bits for a scheduled PDSCH. For example, as illustrated in the “HARQ-ACK codebook” in FIG. 4, the terminal may configure an HARQ-ACK for a scheduled PDSCH.

Note that, the C-DAI is counted up from one. For example, in the case of a two-bit field, the C-DAI is repeated as in 1->2->3->0-> and so forth. The C-DAI is counted up per slot and per DCI reception occasion of each CC, and is counted up from the final value of the previous slot even though the slot changes. The T-DAI represents the final C-DAI value of each slot.

Next, exemplary generation of Type 1 HARQ-ACK CB is described.

### <Generation of Type-1 HARQ-ACK CB>

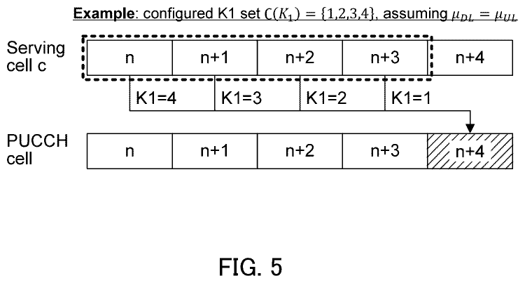

FIGS. 5, 6, and 7 are diagrams for describing exemplary generation of Type-1 HARQ-ACK CB. In FIG. 5, it is assumed that the numerology of a serving cell and the numerology of a PUCCH cell are the same. In FIG. 5, a K1 (offset from PDSCH to HARQ-ACK) set is {1, 2, 3, 4}.

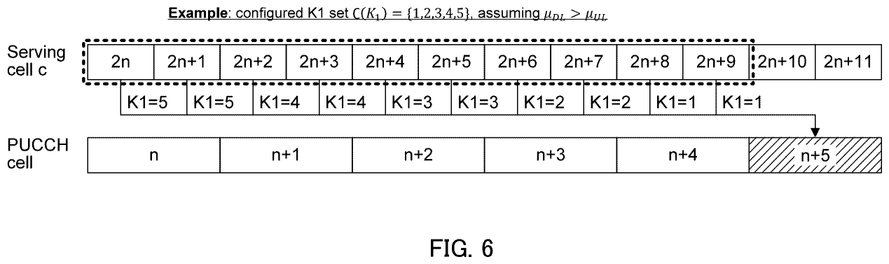

In FIG. 6, it is assumed that the numerology of a serving cell is different from the numerology of a PUCCH cell. In FIG. 6, the K1 set is {1, 2, 3, 4, 5}.

The terminal may generate a HARQ-ACK CB based on the following Step A, Step A-1, Step A-2, and Step B.

### Step A

The terminal determines an HARQ-ACK occasion for candidate PDSCH receptions.

For example, in FIG. 5, the terminal determines the slot of n+4 in the PUCCH cell. For example, in FIG. 6, the terminal determines the slot of n+5 in the PUCCH cell.

### Step A-1

The terminal determines a PDSCH slot window based on the K1 set. For example, the terminal interprets the K1 set in the numerology of the PUCCH cell and determine the PDSCH slot window indicated by the dotted frame in FIG. 5 or 6.

### Step A-2

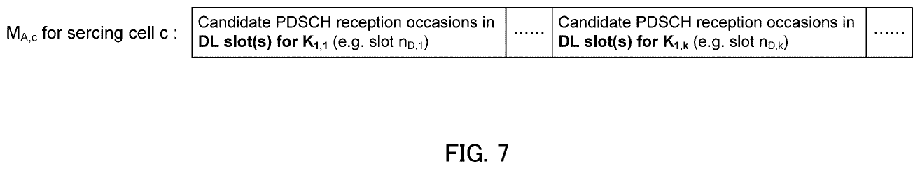

The terminal determines a candidate PDSCH reception occasion in each slot for each K1. For example, as illustrated in M_{A,c} in FIG. 7, the terminal determines a candidate PDSCH reception occasion in each slot.

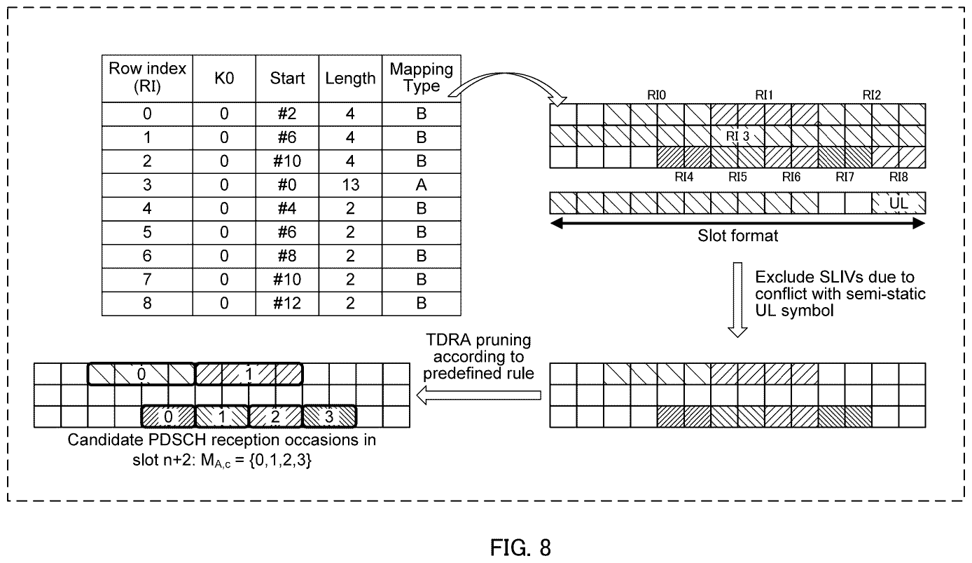

Note that the candidate PDSCH reception occasion, which will be described in FIG. 8, is associated with a set Row index (RI) of a Time Domain Resource Allocation (TDRA) table. The candidate PDSCH reception occasion in the TDRA table overlapping with UL configured by TDD-UL-DL-ConfigurationCommon and TDD-UL-DL-ConfigDedicated is excluded. Regarding the candidate PDSCH reception occasion overlapping in the time domain, the candidate PDSCH reception occasion is determined based on a specific rule.

### Step B

The terminal may determine (generate) an HARQ-ACK (HARQ-ACK information bits, HARQ-ACK CB) for each element of a determined candidate PDSCH reception occasion. For example, the terminal may generate the following Type-1 HARQ-ACK CB for the total number O^{ACK} of HARQ-ACK information bits.

[1]

$${\tilde{O}}_{0}^{ACK} , {\tilde{O}}_{1}^{ACK} , … , {\tilde{O}}_{{O}^{ACK} - 1}^{ACK} \qquad ( Equation 1 )$$

FIG. 8 is a diagram illustrating exemplary determination of candidate PDSCH reception occasions in Step A-2. The table shown in the upper left of FIG. 8 is an example of TDRA. The column of “K0” indicates an offset between the slot of DCI and the slot of PDSCH. The column of “Start” indicates the starting symbol within a slot, and the column of “Length” indicates the length from the Start (the number of symbols allocated to PDSCH). The column of “Mapping Type” is related to a mapping type that includes information on a symbol configurable as the starting symbol of PDSCH within a slot.

A slot format is illustrated in the upper right of FIG. 8. In the example of the slot format illustrated in FIG. 8, the last two symbols are semi-statically configured as UL.

Candidate PDSCH reception occasions based on TDRA RIs 0 to 8 illustrated in the upper left of FIG. 8 are as shown in the upper right of FIG. 8. However, candidate PDSCH reception occasions in the TDRA table overlapping with the UL are excluded.

Thus, the candidate PDSCH reception occasions for RI 2, RI 3, and RI 8 that overlap with UL are excluded, and the candidate PDSCH reception occasions in a certain slot are as shown in the lower right of FIG. 8. That is, HARQ-ACKs for RI 2, RI 3, and RI 8 are excluded from the HARQ-ACK CB generation set.

For the candidate PDSCH reception occasions that overlap in the time domain, candidate PDSCH reception occasions are determined based on a specific rule. Therefore, the final candidate PDSCH reception occasions are as shown in the lower left of FIG. 8, and M_{A,c} in a certain slot becomes M_{A,c}={0, 1, 2, 3}.

Next, exemplary generation of an SPS HARQ-ACK CB will be described. Note that, an SPS HARQ-ACK CB may be regarded as a CB of HARQ-ACKs for SPS PDSCHs. For example, transmission periodicity for SPS PDSCH is configured by RRC. Furthermore, a timing (K1) for transmitting an HARQ-ACK for SPS PDSCH is configured by RRC, for example. The SPS PDSCH is activated and deactivated by DCI, for example. Hereinafter, the DCI that deactivates the SPS PDSCH is sometimes referred to as deactivation DCI. The terminal also transmits an HARQ-ACK for deactivation DCI.

### <Order of HARQ-ACK>

For the Type-1 HARQ-ACK CB only for SPS PDSCH reception, HARQ-ACKs may be ordered as follows.

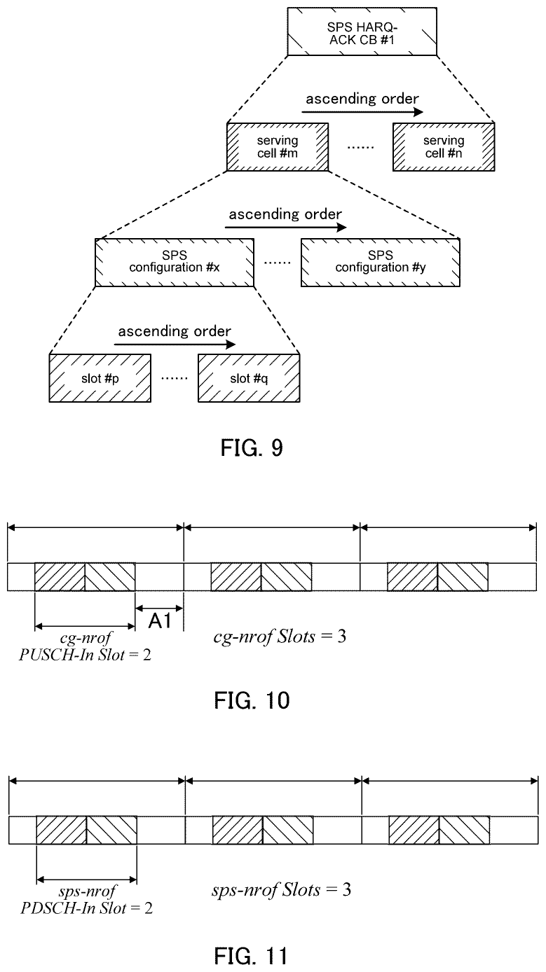

FIG. 9 is a diagram illustrating an example of HARQ-ACK ordering in a Type-1 HARQ-ACK CB for SPS PDSCHs. HARQ-ACKs for SPS PDSCHs are arranged in ascending order of DL slot numbers in each SPS configuration index of each serving cell index. The HARQ-ACKs for SPS PDSCHs are then arranged in ascending order of the SPS configuration indexes in each serving cell index. The HARQ-ACKs for SPS PDSCHs are then arranged in ascending order of the serving cell indexes.

In the Type-2 HARQ-ACK CB for SPS PDSCH reception, HARQ-ACKs may be ordered in the same manner as in the Type-1 HARQ-ACK CB described above. Note that, in the Type-2 HARQ-ACK CB, in a case where an HARQ-ACK for an SPS PDSCH reception is multiplexed with an HARQ-ACK for a dynamically scheduled PDSCH reception and/or an HARQ-ACK for deactivation DCI, the HARQ-ACK (bits) for the SPS PDSCH reception is added following (temporally following) the HARQ-ACK (bits) for the dynamically scheduled PDSCH reception and/or the HARQ-ACK (bits) for deactivation DCI.

### <Analysis 1>

As mentioned above, XR is being considered in Release 17, and the target requirements for XR include capacity, latency, mobility, and energy efficiency. Therefore, it is assumed that SPS PDSCH and/or CG PUSCH will be applied to XR services, and multiple SPS and/or multiple CGs will be used for a single XR packet transmission.

However, it may not be possible for the current SPS PDSCH and CG PUSCH to adequately support XR services. For example, it may not be possible to adequately support XR services with larger payload sizes.

For example, it is specified that one SPS PDSCH is transmitted in a configured SPS transmission periodicity (reception periodicity at a terminal, hereinafter simply referred to as SPS periodicity). Thus, it may not be possible for the current SPS PDSCH to adequately support XR services. In the present embodiment, a terminal receives multiple SPS PDSCHs in an SPS periodicity (for each SPS periodicity). In the present embodiment, a terminal appropriately processes a HARQ-ACK CB in the case of receiving multiple SPS PDSCHs in an SPS periodicity.

Furthermore, for CG PUSCH, multiple PUSCH transmissions in a CG periodicity (grant periodicity) (for each CG periodicity) is specified. However, the current CG PUSCH lacks flexibility, and it may not be possible to adequately support XR services.

FIG. 10 is a diagram illustrating an example of CG PUSCH. The parameters cg-nrofSlots and cg-nrofPUSCH-InSlot are provided to the terminal by a higher layer. The parameter cg-nrofSlots represents the number of consecutive slots allocated in the configured CG periodicity. The parameter cg-nrofPUSCH-InSlot indicates the number of consecutive PUSCH allocations within a slot. FIG. 10 illustrates an example in which cg-nrofSlots=3 and cg-nrofSlots=2. The CG period (period in which CG PUSCHs are transmitted, e.g., three slots in FIG. 10) is repeated with the configured CG periodicity.

The first PUSCH allocation is based on the TDRA of Type 1 CG PUSCH or a higher layer configuration based on TS38.321. Alternatively, the first PUSCH allocation is based on a UL grant received in DCI for Type 2 CG PUSCH. The remaining PUSCH allocations have the same length and mapping type as the first PUSCH. Each PUSCH is added immediately after the previous PUSCH without gaps.

However, the current CG PUSCH lacks flexibility. For example, in the current CG PUSCH, PUSCH cannot be transmitted in the gap between slots (e.g., the part indicated by double-pointed arrow A1 in FIG. 10). Therefore, it may not be possible to adequately support XR services.

### <Analysis 2>

Furthermore, as mentioned above, for the XR in Release 18, it was agreed to support dynamic indication of one or more unused CG PUSCH occasions based on UCI. Thus, for example, the terminal is considered to report the dynamic indication to the base station using CG-UCI.

However, the details of CG-UCI used for dynamically indicating unused CG PUSCH occasions and the dynamic indication by CG-UCI have not been determined.

For example, regarding CG-UCI and CG PUSCH, it is defined that CG-UCI bits are transmitted in CG PUSCH when the higher layer parameter cg-Retransmission Timer is configured, and the mapping of a CG-UCI field, such as HARQ process number, Redundancy version, New data indicator, and Channel Occupancy Time (COT) sharing information, is defined (e.g., 3GPP TS38.212, section 6.3.2.1.3).

However, in the current (existing) CG-UCI, there is no field related to unused CG PUSCH occasions. Thus, a field needs to be added or new CG-UCI separate from the current CG-UCI needs to be provided in order for the current CG-UCI to be used for dynamically indicating unused CG PUSCH occasions.

When the CG-UCI used for dynamically indicating unused CG PUSCH occasions cannot be properly communicated between a base station and a terminal, it may affect the operation of the base station or the terminal, and this may also have a problem in terms of resource utilization efficiency.

Based on the above analysis, the following proposals are made in the present embodiment.

Proposals 1 to 5 are intended to allow the terminal to flexibly respond to a gap between slots for CG PUSCH and a gap between slots for SPS PDSCH.

Furthermore, Proposals 6 to 8 relate to dynamic indication of unused CG PUSCH transmission occasions by CG-UCI. Specifically, proposals are made on whether the report of dynamic indication is made by new CG-UCI or the existing UCI (Issue 1), how to determine or identify the presence of CG-UCI used for dynamic indication of unused CG PUSCH occasions for CG PUSCH (Issue 2), and how to indicate unused CG PUSCH occasions by a CG-UCI field (Issue 3).

### <Proposal 1>

A terminal may receive multiple SPS PDSCHs in the configured SPS periodicity for SPS PDSCHs. The terminal may receive one or more SPS PDSCHs in the slots allocated in the SPS periodicity. The slots allocated in the SPS periodicity may be consecutive.

FIG. 11 is a diagram illustrating an example of SPS PDSCH. For example, parameters sps-nrofSlots and sps-nrofPDSCH-InSlot may be provided for the terminal by a higher layer such as RRC. The parameters sps-nrofSlots and sps-nrofPDSCH-InSlot may be included in the SPS-Config information element of RRC, for example.

The parameter sps-nrofSlots may represent the number of slots which is allocated in the configured SPS periodicity and in which SPS PDSCHs are consecutively transmitted. The parameter sps-nrofPDSCH-InSlot may represent the number of consecutive SPS PDSCH allocations within a slot. FIG. 11 illustrates an example in which sps-nrofSlots=3 and sps-nrofPDSCHSlot=2. The SPS period (period in which SPS PDSCHs are received, e.g., three slots in FIG. 11) is repeated with the configured SPS periodicity.

In the following description, multiple SPS PDSCH receptions in the (per) SPS periodicity is sometimes referred to as multiple PDSCHs. Multiple CG PUSCH transmissions in the (per) CG periodicity is sometimes referred to as multiple PUSCHs. The terminal may apply both or either of multiple PDSCHs and multiple PUSCHs.

### <Proposal 2>

Multiple PDSCHs may be supported for one SPS periodicity. Multiple PUSCHs may be supported for one CG periodicity.

### <Opt.1>

For multiple SPS PDSCHs in one SPS periodicity, individual (different) TDRAs may be respectively indicated or configured. For multiple CG PUSCHs in one CG periodicity, individual TDRAs may be respectively indicated or configured.

### Regarding Type 1 CG PUSCH

In the case of Type 1 CG PUSCH, multiple TDRAs may be configured for a single multiple-PUSCHs configuration.

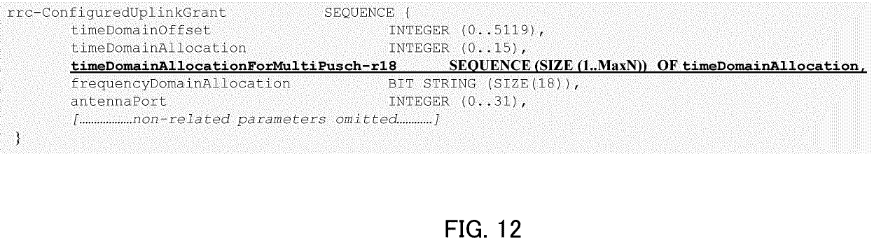

FIG. 12 is a diagram illustrating an exemplary TDRA configuration. For Type 1 CG PUSCH, multiple TDRAs may be configured for a single multiple-PUSCHs configuration based on an RRC parameter, as shown in the underlined part in FIG. 12.

### Regarding Type 2 CG PUSCH and SPS PDSCH

In the case of Type 2 CG PUSCH, multiple TDRAs may be indicated by activation DCI for CG PUSCH for a single multiple-PUSCHs configuration. In the case of SPS PDSCH, multiple TDRAs may be indicated by activation DCI for SPS PDSCH for a single multiple-PDSCHs configuration.

### <Alt.1>

One TDRA field of the activation DCI may indicate an RI of a TDRA table that is a TDRA table with multiple Start and Length Indicator Values (SLIVs) and includes at least one RI.

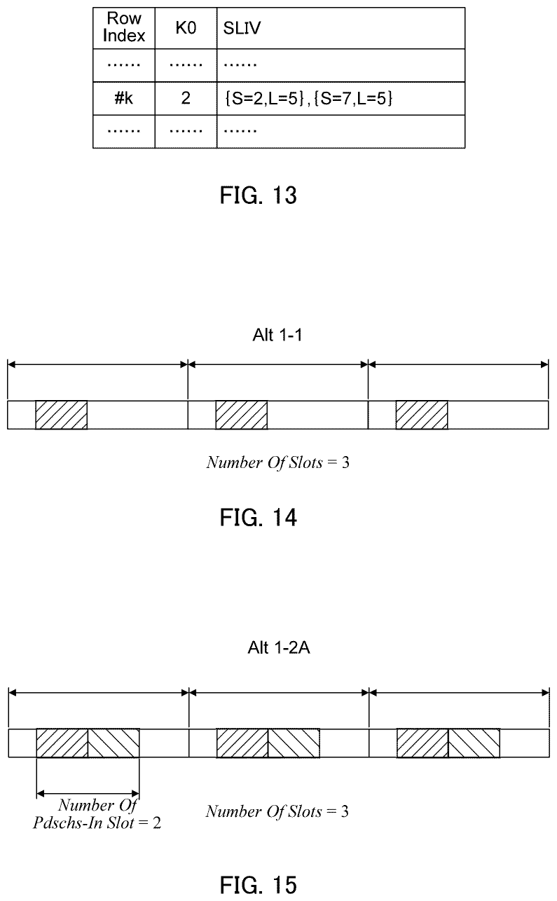

FIG. 13 illustrates exemplary multiple SLIVs in a TDRA table. In FIG. 13, a mapping type is omitted. As illustrated in FIG. 13, one RI in the TDRA table may include multiple SLIVs. For example, RI #k may include two SLIVs: {S=2, L=5} and {S=7, L=5}.

The terminal may refer to the TDRA table based on the RI indicated by the activation DCI to determine (obtain) the SLIVs for multiple CG PUSCHs of multiple PUSCHs.

The terminal may refer to the TDRA table based on the RI indicated by the activation DCI to determine the SLIVs for multiple SPS PDSCHs of multiple PDSCHs.

In Alt.1, there is no impact on (change to) the activation DCI for CG PUSCH. Furthermore, in Alt.1, a TDRA table for multiple PUSCHs scheduling (enhanced in Rel-17) can be reused.

In Alt.1, there is no impact on the activation DCI for SPS PDSCH. Furthermore, in Alt.1, a TDRA table for multiple PDSCHs scheduling (enhanced in Rel-17) can be reused.

### <Alt.2>

The activation DCI for CG PUSCH may include multiple TDRA fields. Each of the multiple TDRA fields may indicate an RI of a TDRA table that includes only one SLIV per row.

For example, a SLIV indicated by the RI of each of the multiple TDRA fields may indicate the SLIV of each CG PUSCH in the CG period.

The activation DCI for SPS PDSCH may include multiple TDRA fields. Each of the multiple TDRA fields may indicate an RI of a TDRA table that includes only one SLIV per row.

For example, a SLIV indicated by the RI of each of the multiple TDRA fields may indicate the SLIV of each SPS PDSCH in the SPS period.

In Alt.2, a TDRA table for single multiple PUSCHs scheduling can be reused.

In Alt.2, a TDRA table for single multiple PDSCHs scheduling can be reused.

### <Opt.2>

In one SPS periodicity, TDRA may be indicated and/or configured for the first SPS PDSCH. In one CG periodicity, TDRA may be indicated and/or configured for the first CG PUSCH.

The TDRAs of subsequent SPS PDSCHs may be determined based on the TDRA of the first SPS PDSCH and the number of SPS PDSCHs in one periodicity. The TDRAs of subsequent CG PUSCHs may be determined based on the TDRA of the first CG PUSCH and the number of CG PUSCHs in one periodicity.

### <Alt.1>

TDRAs of multiple PDSCHs may be allocated in a slot-based manner. TDRAs of multiple PUSCHs may be allocated in a slot-based manner.

For example, the SPS PDSCH resource allocation may be the same in each slot. The number of slots for SPS PDSCHs in one periodicity may be indicated by the activation DCI (if present) or configured by RRC. In the case of being configured by the RRC, the number of SPS PDSCHs may be configured for each configured SPS or configured commonly for all configured SPSs.

For example, the CG PUSCH resource allocation may be the same in each slot. The number of slots for CG PUSCHs in one periodicity may be indicated by the activation DCI (if present) or configured by RRC. In the case of being configured by the RRC, the number of CG PUSCHs may be configured for each configured CG or configured commonly for all configured CGs.

### <Alt.1-1>

One SPS PDSCH may be allocated in one slot. One CG PUSCH may be allocated in one slot.

FIG. 14 is a diagram illustrating an example of Alt.1-1. In the example of FIG. 14, the terminal receives three SPS PDSCHs in the configured SPS periodicity. In the example of FIG. 14, the terminal receives one SPS PDSCH in one slot.

TDRA may be indicated or configured for the SPS PDSCH in the first slot (e.g., the leftmost slot in FIG. 14). The TDRA of the SPS PDSCH in the first slot may be applied to the SPS PDSCH in the remaining slots.

SPS PDSCH is exemplified in FIG. 14, but the same applies to CG PUSCH.

### <Alt.1-2>

Multiple SPS PDSCHs may be allocated in one slot. Multiple CG PUSCHs may be allocated in one slot.

### <Alt.1-2A>

The number of multiple SPS PDSCHs in one slot may be explicitly indicated and/or configured. The number of multiple CG PUSCHs in one slot may be explicitly indicated and/or configured.

The length of each SPS PDSCH may be the same as the length of the first SPS PDSCH. The length of each CG PUSCH may be the same as the length of the first CG PUSCH.

FIG. 15 is a diagram illustrating an example of Alt.1-2A. In the example of FIG. 15, the number of slots which is allocated in the configured SPS periodicity and in which SPS PDSCHs are consecutively transmitted is three. The terminal receives two SPS PDSCHs in each slot.

The number of multiple SPS PDSCHs in one slot may be explicitly indicated and/or

configured. For example, the number “2” of multiple SPS PDSCHs in one slot illustrated in FIG. 15 may be explicitly indicated and/or configured by a higher layer parameter such as DCI or RRC. Furthermore, the lengths of the SPS PDSCHs illustrated in FIG. 15 may be the same as the length of the first SPS PDSCH.

SPS PDSCH is exemplified in FIG. 15, but the same applies to CG PUSCH.

### <Alt.1-2B>

The number of multiple SPS PDSCHs in one slot may be implicitly determined as the maximum allowable number of PDSCHs in the slot, assuming that the lengths of the PDSCHs are equal to the length of the first PDSCH. The number of multiple CG PUSCHs in one slot may be implicitly determined as the maximum allowable number of PUSCHs in the slot, assuming that the lengths of the PUSCHs are equal to the length of the first PUSCH.

### <Alt.1-2B-1>

The last SPS PDSCH in a slot may be shorter than the first SPS PDSCH. The last CG PUSCH in a slot may be shorter than the first CG PUSCH.

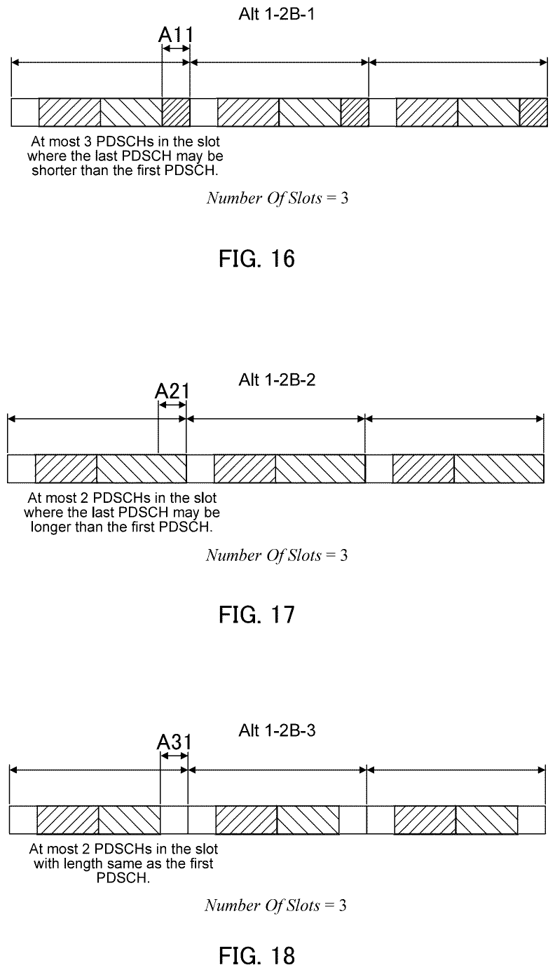

FIG. 16 is a diagram illustrating an example of Alt.1-2B-1. In the example of FIG. 16, the number of slots which is allocated in the configured SPS periodicity and in which SPS PDSCHs are consecutively transmitted is three.

The terminal may implicitly determine the maximum allowable number of SPS PDSCHs in one slot in the time domain based on the length of the SPS PDSCH and the slot length, assuming that the lengths of the PDSCHs are equal to the length of the first PDSCH. In the example of FIG. 16, the maximum allowable number of SPS PDSCHs in a slot is three. The lengths of the first and second SPS PDSCHs in one slot are the same, but the length of the last SPS PDSCH in one slot may be shorter than those of the other SPS PDSCHs.

The terminal may allocate the first SPS PDSCH to a slot based on TDRA, for example. The terminal may consecutively allocate an SPS PDSCH having the same length as the first SPS PDSCH to fit within the slot. The terminal may allocate an SPS PDSCH shorter than the first SPS PDSCH for the resource (symbol) where the consecutive SPS PDSCHs in the slot have not fitted (e.g., part indicated by double-pointed arrow A11 in FIG. 16).

SPS PDSCH is exemplified in FIG. 16, but the same applies to CG PUSCH.

### <Alt.1-2B-2>

The last SPS PDSCH in a slot may be longer than the first SPS PDSCH. The last CG PUSCH in a slot may be longer than the first CG PUSCH.

FIG. 17 is a diagram illustrating an example of Alt.1-2B-2. In the example of FIG. 17, the number of slots which is allocated in the configured SPS periodicity and in which SPS PDSCHs are consecutively transmitted is three.

The terminal may implicitly determine the maximum allowable number of SPS PDSCHs in one slot in the time domain based on the length of the SPS PDSCH and the slot length, assuming that the lengths of PDSCHs are equal to the length of the first PDSCH. In the example of FIG. 17, the maximum allowable number of SPS PDSCHs in a slot is two. The length of the second SPS PDSCH (the last SPS PDSCH in one slot) may be longer than that of the other SPS PDSCH.

The terminal may allocate the first SPS PDSCH to a slot based on TDRA, for example. The terminal may consecutively allocate an SPS PDSCH having the same length as the first SPS PDSCH to fit within the slot. The terminal may make the length of the last SPS PDSCH (the second SPS PDSCH in the example of FIG. 17) longer than that of the other SPS PDSCH for the resource (symbol) where the consecutive SPS PDSCHs in the slot have not fitted (e.g., part indicated by double-pointed arrow A21 in FIG. 17).

SPS PDSCH is exemplified in FIG. 17, but the same applies to CG PUSCH.

### <Alt.1-2B-3>

The last remaining symbol in a slot having the length shorter than the length of the first SPS PDSCH may be dropped. The last remaining symbol in a slot having the length shorter than the length of the first CG PUSCH may be dropped.

FIG. 18 is a diagram illustrating an example of Alt.1-2B-3. In the example of FIG. 18, the number of slots which is allocated in the configured SPS periodicity and in which SPS PDSCHs are consecutively transmitted is three.

The terminal may implicitly determine the maximum allowable number of SPS PDSCHs in one slot in the time domain based on the length of the SPS PDSCH and the slot length, assuming that the lengths of the PDSCHs are equal to the first PDSCH length. In the example of FIG. 18, the maximum allowable number of SPS PDSCHs in a slot is two. The terminal may drop the SPS PDSCH for the resource shorter than the SPS PDSCH in one slot.

The terminal may allocate the first SPS PDSCH to a slot based on TDRA, for example. The terminal may allocate consecutive an SPS PDSCH having the same length as the first SPS PDSCH to fit within the slot. The terminal may drop (need not allocate) the SPS PDSCH for the resource (symbol) where the consecutive SPS PDSCHs in the slot have not fitted (e.g., part indicated by double-pointed arrow A31 in FIG. 18).

SPS PDSCH is exemplified in FIG. 18, but the same applies to CG PUSCH.

### <Alt.2>

Multiple SPS PDSCHs may be consecutively allocated in one periodicity based on TDRA. Multiple CG PUSCHs may be consecutively allocated in one periodicity based on TDRA.

For example, as in the case of PUSCH-repetition type B, multiple SPS PDSCHs may be consecutively allocated across slots. For example, as in the case of PUSCH-repetition type B, multiple CG PUSCHs may be consecutively allocated across slots. This enables low-latency communication.

In a case where the SPS PDSCH allocated by TDRA spans slots, a nominal SPS PDSCH may be split into two actual PDSCHs, similarly to PUSCH-repetition type B. In a case where the CG PUSCH allocated by TDRA spans slots, a nominal CG PUSCH may be split into two actual PUSCHs, similarly to PUSCH-repetition type B.

The numbers of SPS PDSCHs and CG PUSCHs may be counted based on the following Alt.2-1 or Alt.2-2.

### <Alt.2-1>

The number of SPS PDSCHs may be counted based on nominal SPS PDSCHs. The number of CG PUSCHs may be counted based on nominal SPS PDSCHs.

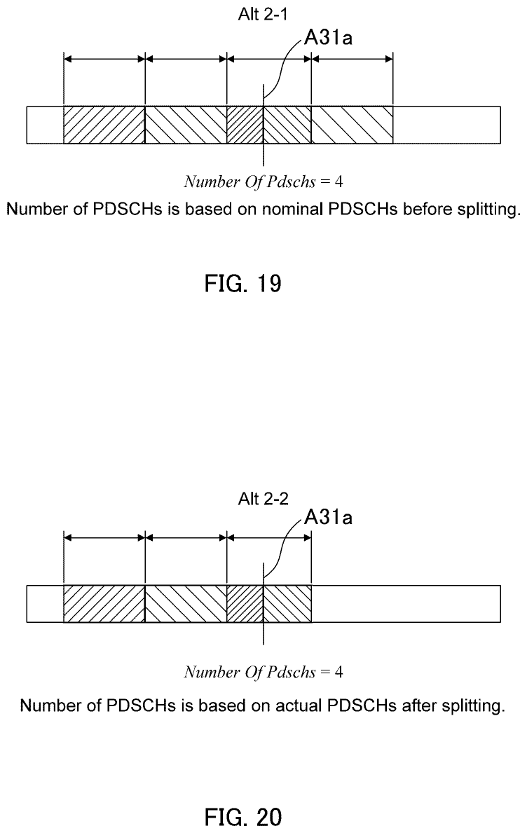

FIG. 19 is a diagram illustrating an example of Alt.2-1. Line A31a shown in FIG. 19 indicates a slot boundary. In FIG. 19, the number of SPS PDSCHs in the SPS periodicity is set to four (sps-nrofSlots=4).

In Alt.2-1, the number of SPS PDSCHs is counted based on nominal SPS PDSCHs. That is, the number of SPS PDSCHs is counted in the state before one of the SPS PDSCHs is split across slots. For example, the SPS PDSCH split at the slot boundary is counted as one.

Thus, in the case where the number of SPS PDSCHs in the SPS periodicity is four and one SPS PDSCH spans slots, the nominal SPS PDSCHs are allocated to resources as illustrated in FIG. 19. The terminal decodes the nominal SPS PDSCHs allocated to the resources.

SPS PDSCH is exemplified in FIG. 19, but the same applies to CG PUSCH.

### <Alt.2-2>

The number of SPS PDSCHs may be counted based on actual SPS PDSCHs. The number of CG PUSCHs may be counted based on actual SPS PDSCHs.

FIG. 20 is a diagram illustrating an example of Alt.2-2. Line A31b shown in FIG. 20 indicates a slot boundary. In FIG. 20, the number of SPS PDSCHs in the SPS periodicity is set to four (sps-nrofSlots=4).

In Alt.2-2, the number of SPS PDSCHs is counted based on actual SPS PDSCHs. That is, the number of SPS PDSCHs is counted in the state after one of the SPS PDSCHs is split across slots. For example, the SPS PDSCH split at the slot boundary is counted as two. Thus, in the case where the number of SPS PDSCHs in the SPS periodicity is four and one SPS PDSCH spans slots, the actual SPS PDSCHs are allocated to resources as illustrated in FIG. 20. The terminal decodes the actual SPS PDSCHs allocated to the resources.

SPS PDSCH is exemplified in FIG. 20, but the same applies to CG PUSCH.

Note that, in Alt.2 of Proposal 1, the number of SPS PDSCHs transmitted in the SPS periodicity may be indicated by activation DCI (if present) or configured by RRC. In the case where the number of SPS PDSCHs is configured by RRC, the number of SPS PDSCHs may be configured for each configured SPS or configured commonly for all configured SPSs.

Furthermore, in Alt.2 of Proposal 1, the number of CG PUSCHs transmitted in the CG periodicity may be indicated by activation DCI (if present) or configured by RRC. In the case where the number of CG PUSCHs is configured by RRC, the number of CG PUSCHs may be configured for each configured CG or configured commonly for all configured CGs.

### <Proposal 3>

To multiple PDSCHs, a parameter other than TDRA, such as Frequency Domain Resource Allocation (FDRA), Modulation Coding Scheme (MCS), Redundancy Version (RV), Transmission Configuration Indication (TCI) state, or SRS resource indicator (SRI), may be applied. To multiple PUSCHs, a parameter other than TDRA, such as FDRA, MCS, RV, TCI state, or SRI, may be applied.

### <Opt.1>

The above parameters may be commonly indicated and/or configured for all SPS PDSCHs in one SPS periodicity. The above parameters may be commonly indicated and/or configured for all CG PUSCHs in one CG periodicity.

### <Opt.2>

The above parameters may be individually indicated and/or configured for each SPS PDSCH in one SPS periodicity. The above parameters may be individually indicated and/or configured for each CG PUSCH in one CG periodicity.

For Type 1 CG PUSCH, rrc-ConfiguredUplinkGrant may be used for the individual configuration of the above parameters. For Type 1 CG PUSCH and SPS PDSCH, an individual field for the above parameter may be included in the activation DCI for CG and the activation DCI for SPS.

### <Proposal 4>

The actual transmission (reception at the terminal) of PDSCH may occur for all SPS PDSCHs or some of SPS PDSCHs in one SPS periodicity. The actual transmission of PUSCH may occur for all CG PUSCHs or some of CG PUSCHs in one CG periodicity.

### <Opt.1>

Actual reception may occur for all SPS PDSCHs in the SPS periodicity or for the first specific SPS PDSCH in the SPS periodicity. Actual transmission may occur for all CG PUSCHs in the CG periodicity or for the first specific CG PUSCH in the CG periodicity.

For example, the terminal may receive PDSCHs in six SPS PDSCHs of multiple PDSCHs illustrated in FIG. 15, or receive a PDSCH in the SPS PDSCH shown at the leftmost among the six SPS PDSCHs illustrated in FIG. 15.

The number of actual receptions in one SPS periodicity and the number of actual transmissions in one CG periodicity may be determined according to the following Alt.1 or Alt.2.

### <Alt.1>

The number of actual receptions in one SPS periodicity may be determined by blind detection. The number of actual transmissions in one CG periodicity may be determined by blind detection.

In the determination by blind detection, when it is determined that there is no actual reception for a certain SPS PDSCH, the terminal need not perform blind detection on an SPS PDSCH following the certain SPS PDSCH. In the determination by blind detection, when it is determined that there is no actual transmission for a certain CG PUSCH, the base station need not perform blind detection on a CG PUSCH following the certain CG PUSCH.

For example, when the terminal determines that there is no actual reception for the second SPS PDSCH from the left among the nine SPS PDSCHs of multiple PDSCHs illustrated in FIG. 16, the terminal need not perform blind detection of the actual reception number on the third and subsequent SPS PDSCHs.

### <Alt.2>

The number of actual receptions in one SPS periodicity may be indicated by control information included in the first SPS PDSCH in the SPS periodicity. The number of actual transmissions in one CG periodicity may be indicated by control information included in the first CG PUSCH in the CG periodicity.

The control information included in the first SPS PDSCH in the SPS periodicity may indicate that there are N actual PDSCH receptions in this SPS periodicity. The letter N may be a number equal to or less than the maximum number of SPS PDSCHs included in one SPS periodicity. When the N is less than the maximum number of SPS PDSCHs, the terminal need not perform blind detection on the (N+1)th SPS PDSCH included in one SPS periodicity.

The control information included in the first CG PUSCH in the CG periodicity may indicate that there are N actual PUSCH transmissions in this CG periodicity. The letter N may be a number equal to or less than the maximum number of CG PUSCHs included in one CG periodicity. When the N is less than the maximum number of CG PUSCHs, the base station need not perform blind detection on the (N+1)th PUSCH included in one CG periodicity.

### <Opt.2>

There may be a case where no actual reception occurs for all SPS PDSCHs in one SPS periodicity. For example, it is conceivable that no actual reception occurs at a certain timing even though a large number of SPS PDSCH candidates has been configured in one slot in response to a request for XR service (see, e.g., FIG. 16).

Thus, the terminal may perform blind detection of SPS PDSCH on all SPS PDSCH reception occasions. Note that, even when the terminal determines that there is no actual reception for a certain SPS PDSCH in one SPS periodicity, the terminal performs blind detection on the remaining SPS PDSCHs.

There may be a case where no actual transmission occurs for all CG PUSCHs in one CG periodicity. For example, it is conceivable that no actual reception occurs at a certain timing even though a large number of CG PUSCH candidates has been configured in one slot in response to a request for XR service.

Thus, the base station may perform blind detection of CG PUSCH on all CG PUSCH reception occasions. Note that, even when the base station determines that there is no actual transmission for a certain CG PUSCH in one CG periodicity, the base station performs blind detection on the remaining CG PUSCHs.

### <Proposal 5>

In Proposal 5, HARQ-ACK feedback in one SPS periodicity of multiple PDSCHs will be described.

### Regarding HARQ-ACK Timing

### <Alt.1>

The timing of HARQ-ACK reporting may be determined individually for each SPS PDSCH. Thus, HARQ-ACKs exist for the number of SPS PDSCHs, and multiple K1 values may also exist.

The K1 may be indicated to the terminal by activation DCI for each configured SPS PDSCH. Alternatively, one K1 value may be indicated to the terminal by activation DCI and commonly applied to the configured SPS PDSCHs.

### <Alt.2>

The HARQ-ACK feedback for multiple SPS PDSCHs in one SPS periodicity may be reported in one PUCCH. For example, HARQ-ACKs for the nine SPS PDSCHs illustrated in FIG. 16 may be reported in one PUCCH. The transmission timing of the PUCCH may be determined based on the K1 indicated by activation DCI and the first or last SPS PDSCH slot in the SPS period.

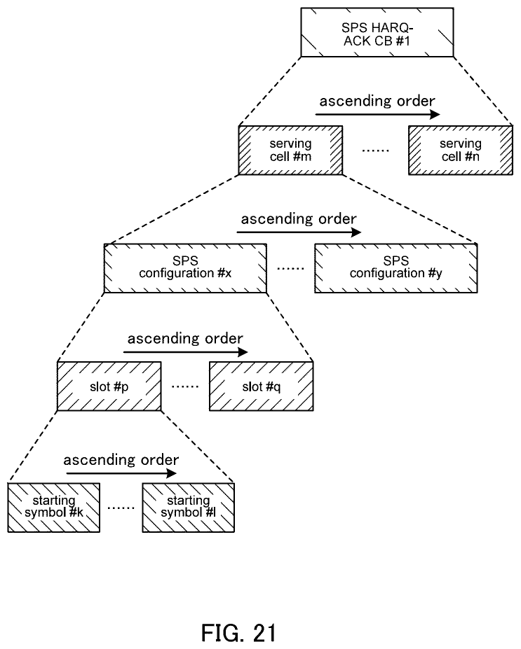

Regarding Type 1 HARQ-ACK CB and Type 2 HARQ-ACK CB with only SPS PDSCHs of multiple PDSCHs. FIG. 21 is a diagram illustrating an example of the HARQ-ACK ordering in Type 1 HARQ-ACK CB of multiple PDSCHs. The HARQ-ACKs for SPS PDSCHs of multiple PDSCHs are arranged in ascending order of the starting symbol (number) of SPS PDSCH in each DL slot number in each SPS configuration index in each serving cell index. Then, the HARQ-ACKs for SPS PDSCHs are arranged in ascending order of the DL slot number in each SPS configuration index in each serving cell index. Thereafter, the HARQ-ACKs of SPS PDSCHs are arranged in ascending order of the SPS configuration index in each serving cell index. Finally, the HARQ-ACKs of SPS PDSCHs are arranged in ascending order of the serving cell index.

For the Type 2 HARQ-ACK CB for SPS PDSCH reception, the HARQ-ACKs may be ordered similarly to the above-mentioned Type 1 HARQ-ACK CB. Note that, in the Type-2 HARQ-ACK CB, in a case where an HARQ-ACK for SPS PDSCH reception is multiplexed with an HARQ-ACK for dynamically scheduled PDSCH reception and/or an HARQ-ACK for deactivation DCI, the HARQ-ACK (bits) for the SPS PDSCH reception is added following (temporally following) the HARQ-ACK (bits) for dynamically scheduled PDSCH reception and/or the HARQ-ACK (bits) for the deactivation DCI.

Regarding Type 1 HARQ-ACK feedback for SPS PDSCH and dynamic PDSCH of multiple PDSCHs. In a case where an individual TDRA is indicated and/or configured for each SPS PDSCH (see, e.g., Opt.1 of Proposal 2), the procedure of generating Type 1 HARQ-ACK CB may follow the generation procedure in Rel.-15 or Rel.-16. Additionally, the procedure of generating Type 1 HARQ-ACK CB may follow the procedure of generating HARQ-ACK CB for multi-PDSCH scheduling that is being discussed in Rel.-17.

In a case where only the TDRA for the first SPS PDSCH is indicated and/or configured (see, e.g., Opt.2 of Proposal 2), the following Opt. 1 or Opt.2 may be applied.

### <Opt.1>

Multiple candidate PDSCH reception occasions for one SLIV may be determined as follows.

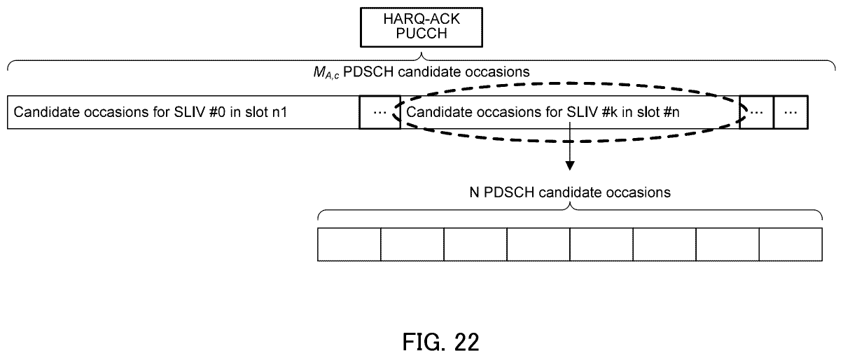

FIG. 22 is a diagram illustrating an example of candidate PDSCH reception occasions.

(1) In a case where the timing of HARQ-ACK reporting is determined individually for each SPS PDSCH, the number N of multiple candidate PDSCH reception occasions for one SLIV may be determined by the maximum number of SPS PDSCHs in one slot.

For example, in the example of FIG. 16, in a case where the timing of HARQ-ACK reporting is determined individually for each SPS PDSCH, the number N of candidate PDSCH reception occasions may be three.

(2) In a case where the HARQ-ACKs for multiple SPS PDSCHs in one SPS periodicity is reported in one PUCCH, the number of multiple candidate PDSCH reception occasions for one SLIV may be determined by the maximum number of SPS PDSCHs in one SPS periodicity.

For example, in the example of FIG. 16, in a case where the HARQ-ACKs for multiple SPS PDSCHs in one SPS periodicity is reported in one PUCCH, the number of candidate PDSCH reception occasions may be nine.

### <Opt.2>

One candidate PDSCH reception occasion for one SLIV may be determined as follows.

### <Opt.2-1>

A PDSCH slot set (PDSCH slot window) may be extended or a K1 set may be extended.

### Step 1

In a case where multiple PDSCH scheduling is not enabled or configured, a PDSCH slot set or K1 set may be extended based on the maximum number of PDSCH slots in one SPS periodicity.

In a case where multiple PDSCH scheduling is enabled or configured, a PDSCH slot set or K1 set may be extended based on the maximum value between the “maximum number of PDSCH slots in one SPS periodicity” and the “maximum number of PDSCH slots for multiple PDSCH scheduling by one DCI.”

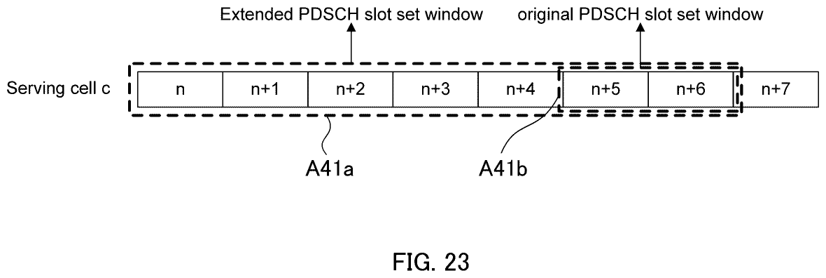

FIG. 23 is a diagram illustrating an example of an extended PDSCH slot set. One SPS periodicity includes multiple SPS PDSCHs. In a case where K1 is configured (extended) for each of the multiple SPS PDSCHs, the PDSCH slot set may be extended as shown in the dotted frame A41a in FIG. 23. Note that the dotted frame A41b in FIG. 23 indicates a PDSCH slot set obtained from the K1 value of the first SPS PDSCH in one SPS periodicity, for example.

### Step 2

Candidate PDSCH reception occasions in each candidate PDSCH slot after K1 extension may be determined based on a SLIV set in each row of the TDRA table.

Note that Opt.2-1 of Proposal 5 is applied to a case of slot-based multiple PDSCHs where one PDSCH is included in one slot, and where the HARQ-ACKs for multiple SPS PDSCHs in one SPS periodicity is reported in one PUCCH. For example, Opt.2-1 of Proposal 5 is applied to the case of Alt.1-1 of Opt.2 of Proposal 2 (see, e.g., FIG. 14).

### <Opt.2-2>

A PDSCH slot set may be extended, and each row of the TDRA table may be extended.

### Step 1

A PDSCH slot set or K1 set is extended similarly to Step 1 of the above Opt.2-1.

### Step 2

For each row of the TDRA table, the SLIV may be extended assuming that the SLIV in the original TDRA table is for the first PDSCH (SPS PDSCH) in one slot. The SLIV of a PDSCH following the first PDSCH in the same slot may be added to the row of the TDRA table.

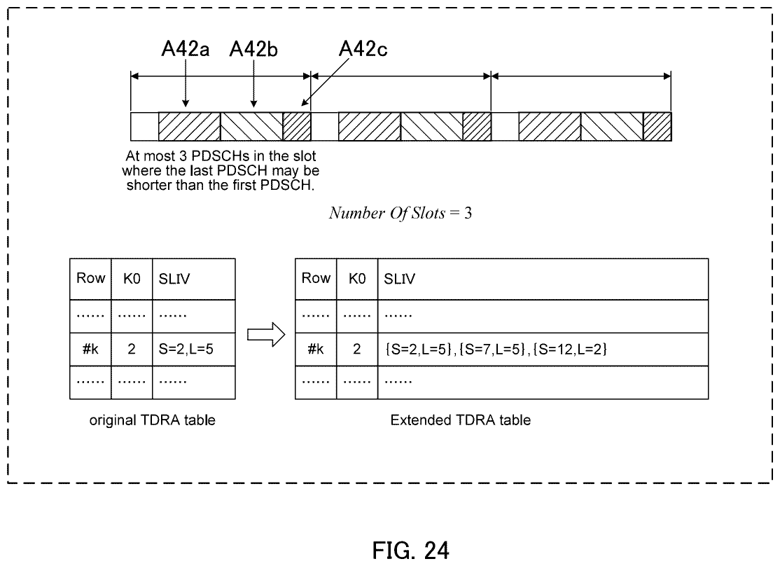

FIG. 24 is a diagram illustrating an example of SLIV extension. The table shown in the lower left of FIG. 24 illustrates an original TDRA table. In the original TDRA table, the SLIV of the first PDSCH in one slot is included.

The table shown in the lower right of FIG. 24 illustrates an extended TDRA table. In the extended TDRA table, in addition to the SLIV of the first PDSCH in one slot, SLIVs of PDSCHs following the first PDSCH are included.

For example, the SLIV {S=2, L=5} in RI #k in the extended TDRA table indicates the SLIV of the SPS PDSCH shown by arrow A42a in FIG. 24. The SLIV {S=7, L=5} indicates the SLIV of the SPS PDSCH shown by arrow A42b in FIG. 24. The SLIV {S=12, L=2} indicates the SLIV of the SPS PDSCH shown by arrow A42c in FIG. 24.

### Step 3

Candidate PDSCH reception occasions in each candidate PDSCH slot after K1 extension may be determined based on the SLIV set in each row of the extended TDRA table.

Note that Opt.2-2 of Proposal 5 is applied to a case where slot-based multiple PDSCHs where multiple PDSCHs are included in one slot, and where HARQ-ACKs for multiple SPS PDSCHs in one SPS periodicity is reported in one PUCCH. For example, Opt.2-2 of Proposal 5 is applied to the case of Alt.1-2 of Opt.2 of Proposal 2 (see e.g., FIG. 15).

### <Opt.2-3>

In each row of the TDRA table, the SLIV may be extended.

### Step 1

For each row of the TDRA table, the SLIV may be extended assuming that the SLIV is for the first PDSCH in one SPS periodicity. The SLIVs of PDSCHs following the first PDSCH in one SPS periodicity may be added to the row of the TDRA table, assuming the maximum number of SPS PDSCHs in one SPS periodicity.

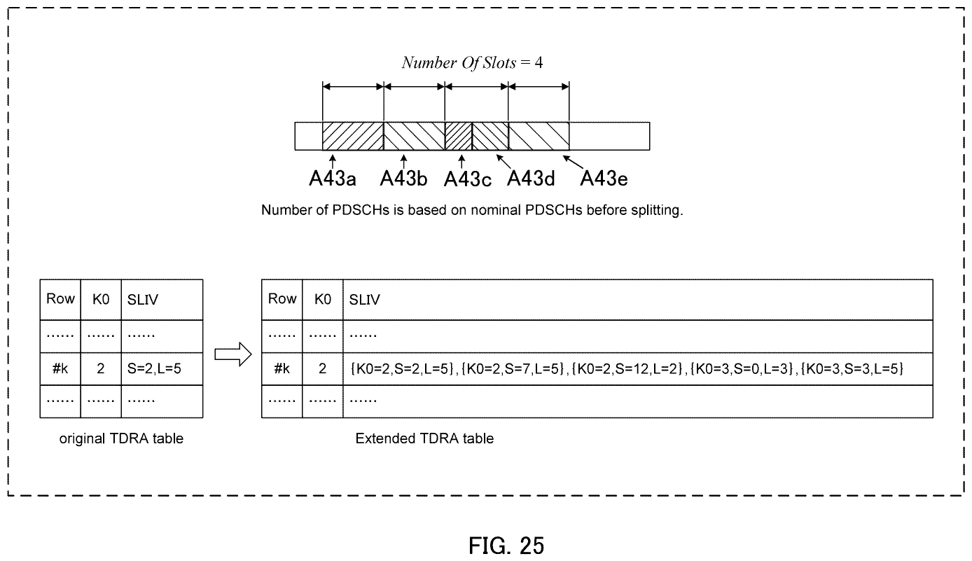

FIG. 25 is a diagram illustrating an example of SLIV extension. The table shown in the lower left of FIG. 25 illustrates an original TDRA table. In the original TDRA table, the SLIV of the first PDSCH in one slot is included.

The table shown in the lower right of FIG. 25 illustrates an extended TDRA table.

In the extended TDRA table, in addition to the SLIV of the first PDSCH in one SPS periodicity, SLIVs of PDSCHs following the first PDSCH are included.

For example, the SLIV {K0=2, S=2, L=5} in RI #k in the extended TDRA table indicates the SLIV of the SPS PDSCH shown by arrow A43a in FIG. 25. The SLIV {K0=2, S=7, L=5} indicates the SLIV of the SPS PDSCH shown by arrow A43b in FIG. 25. The SLIV {K0=2, S=12, L=2} indicates the SLIV of the SPS PDSCH shown by arrow A43c in FIG. 25. The SLIV {K0=3, S=0, L=3} indicates the SLIV of the SPS PDSCH shown by arrow A43d in FIG. 25. The SLIV {K0=3, S=3, L=5} indicates the SLIV of the SPS PDSCH shown by arrow A43e in FIG. 25.

### Step 2

The determination of candidate PDSCH slots and candidate PDSCH reception occasions may follow the determination of multiple PDSCH scheduling in Rel.-17.

Note that Opt.2-3 of Proposal 5 is applied to a case of slot-based multiple PDSCHs where one PDSCH is included in one slot, and a case of slot-based multiple PDSCHs where multiple PDSCHs are included in one slot. For example, Opt.2-3 of Proposal 5 is applied to Alt.1 and Alt.2 of Opt.2 of Proposal 2 (see, e.g., FIGS. 14 to 18).

### <Proposal 6>

In Proposal 6, the following options are proposed for a method for a terminal to dynamically indicate unused CG PUSCH transmission occasions (unused CG PUSCH occasion) by CG-UCI.

### <Option 1>

In a case where a specific higher layer parameter such as cg-RetransmissionTimer is present, a terminal dynamically indicates unused CG PUSCH occasions using new CG-UCI different from the existing CG-UCI.

In Option 1, when both new CG-UCI and the existing CG-UCI that share the spectrum are present, the CG PUSCH can include two pieces of CG-UCI.

### <Option 2>

In a case where the existing CG-UCI includes a new UCI field in addition to the legacy UCI field to indicate unused CG PUSCH occasions, the terminal dynamically indicates unused CG PUSCH occasions using the existing CG-UCI.

In Option 2, the terminal transmits a maximum of one piece of CG-UCI with CG PUSCH.

### <Proposal 7>

Whether new CG-UCI is present as in Option 1 of Proposal 6 or whether a new CG-UCI field is present in the existing CG-UCI may be determined as in the following examples.

### <Option 1>

In Option 1 of Proposal 7, whether new CG-UCI is present or whether a new CG-UCI field is present in the existing CG-UCI is defined by the specification. Hereinafter, Option 1 is described with Examples 1 and 2.

### Example 1

In a case where the terminal reports the capability to dynamically indicate (report) unused CG PUSCH occasions by CG-UCI, the terminal always assumes that new CG-UCI is present or a new CG-UCI field is present in the existing CG-UCI with each actually transmitted CG PUSCH.

### <Variation of Example 1>

The terminal may always assume that new CG-UCI is present or a new CG-UCI field is present in the existing CG-UCI with each actually transmitted CG PUSCH in at least one of the following cases:
Case where the CG PUSCH is a type 1 (or type 2) CG PUSCH;
Case where the CG PUSCH has a high (or low) physical priority;
Case where the CG PUSCH is repeatedly transmitted (or not transmitted); and/or
Case where there is one (or multiple) CG PUSCH occasion(s) in one CG period.

### Example 2

In a case where the terminal reports the capability to dynamically indicate (report) unused CG PUSCH occasions by CG-UCI, the terminal may determine whether new CG-UCI is present or whether a new CG-UCI field is present in the existing CG-UCI, based on specific conditions.

These conditions may include whether multiple CG configurations are configured and/or whether multiple CG PUSCH occasions are configured/indicated within one CG period.

### Example 2-1

In a case where multiple CG configurations are configured or activated, the terminal determines that new CG-UCI (or a new CG-UCI field in the existing CG-UCI) is present with each (actually transmitted) CG PUSCH. In a case where multiple CG configurations are not configured or activated, the terminal determines that new CG-UCI (or a new CG-UCI field in the existing CG-UCI) is not present with CG PUSCH.

### <Variation of Example 2-1>

In at least one of the following cases, the terminal may determine new CG-UCI (or a new CG-UCI field in the existing CG-UCI) that is present with each (actually transmitted) CG PUSCH:
Case where the CG PUSCH is a type 1 (or type 2) CG PUSCH;
Case where the CG PUSCH has a high (or low) physical priority;
Case where the CG PUSCH is repeatedly transmitted (or not transmitted); and/or
Case where there is one (or multiple) CG PUSCH occasion(s) in one CG period.

### Example 2-2

In a case where multiple CG PUSCH occasions are configured/indicated in the CG configuration, the terminal determines that new CG-UCI (or a new CG-UCI field in the existing CG-UCI) is present with the first (or last) X (actually transmitted) CG PUSCHs in the CG configuration. In a case where multiple CG PUSCH occasions are not configured/indicated in the CG configuration, the terminal determines that new CG-UCI (or a new CG-UCI field in the existing CG-UCI) is not present with CG PUSCH in the CG configuration.

### <Variation of Example 2-2>

In at least one of the following cases, the terminal may determine new CG-UCI (or a new CG-UCI field in the existing CG-UCI) that is present with each (actually transmitted) CG PUSCH:
Case where the CG PUSCH is a type 1 (or type 2) CG PUSCH;
Case where the CG PUSCH has a high (or low) physical priority;
Case where the CG PUSCH is repeatedly transmitted (or not transmitted); and/or
Case where there is one (or multiple) CG PUSCH occasion(s) in one CG period.

### <Option 2>

In Option 2 of Proposal 7, whether new CG-UCI is present or whether a new CG-UCI field is present in the existing CG-UCI is specified by a higher layer configuration (e.g., RRC configuration) and/or dynamic indication. Hereinafter, Option 2 is described with Examples 3 and 4.

### Example 3

The presence of new CG-UCI (or a new CG-UCI field in the existing CG-UCI) is commonly configured/indicated for all CG PUSCHs.

### Example 3-1

In a case where the presence of new CG-UCI (or a new CG-UCI field in the existing CG-UCI) is configured by RRC, the terminal always assumes that new CG-UCI (or a new CG-UCI field in the existing CG-UCI) is present with each (actually transmitted) CG-PUSCH. Note that the presence of new CG-UCI (or a new CG-UCI field in the existing CG-UCI) is not configured by RRC, new CG-UCI (or a new CG-UCI field in the existing CG-UCI) is not present in any CG-PUSCH.

### Example 3-2

In a case where the presence of new CG-UCI (or a new CG-UCI field in the existing CG-UCI) is indicated by dynamic indication, the terminal always assumes that new CG-UCI (or a new CG-UCI field in the existing CG-UCI) is present with each (actually transmitted) CG-PUSCH. Note that, in a case where the presence of new CG-UCI (or a new CG-UCI field in the existing CG-UCI) is not indicated by dynamic indication, new CG-UCI (or a new CG-UCI field in the existing CG-UCI) is not present in any CG-PUSCH.

Here, the dynamic indication may have an arbitrary configuration or may be activation DCI of MAC CE.

### <Variation of Example 3>

In at least one of the following cases, the terminal may always assume that new CG-UCI is present or a new CG-UCI field in the existing CG-UCI is present with each (actually transmitted) CG PUSCH:
Case where the CG PUSCH is a type 1 (or type 2) CG PUSCH;
Case where the CG PUSCH has a high (or low) physical priority;
Case where the CG PUSCH is repeatedly transmitted (or not transmitted);
Case where there is one (or multiple) CG PUSCH occasion(s) in one CG period of the CG configuration; and/or
Case where there are X CG PUSCH occasions from the start (or end) when there is one (or multiple) CG PUSCH occasion(s) in one CG period.

### Example 4

The presence of new CG-UCI (or a new CG-UCI field in the existing CG-UCI) is configured/indicated for each CG configuration.

For example, in a case where the presence of new CG-UCI (or a new CG-UCI field in the existing CG-UCI) for the CG configuration is configured by RRC or indicated by the activation DCI for the CG configuration, the new CG-UCI (or the new CG-UCI field in the existing CG-UCI) is present with each (actually transmitted) CG PUSCH of the CG configuration. Otherwise, new CG-UCI (or a new CG-UCI field in the existing CG-UCI) is not present for any of the CG PUSCHs of the CG configuration.

### <Variation of Example 4>

In at least one of the following cases, the terminal does not assume that new CG-UCI (or a new CG-UCI field in the existing CG-UCI) is configured/indicated to be present for the CG configuration:
Case where the CG configuration is a type 1 (or type 2) CG configuration;
Case where the CG configuration has a high (or low) physical priority;
Case where the CG configuration is repeatedly transmitted (or not transmitted);
Case where there is one (or multiple) CG PUSCH occasion(s) in one CG period of the CG configuration; and/or
Case where there is one (or multiple) CG PUSCH occasion(s) in one CG period of the CG configuration.

Here, the presence of new CG-UCI (or a new CG-UCI field in the existing CG-UCI) for the CG configuration may be indicated by MAC CE.

### <Variation of Proposal 2>

In a case where new CG-UCI (or a new CG-UCI field in the existing CG-UCI) is determined to be present with CG PUSCH with repetition, the new CG-UCI (or the new CG-UCI field in the existing CG-UCI) may be present only in the first repetition or in each repetition of the CG PUSCH.

In a case where new CG-UCI (or a new CG-UCI field in the existing CG-UCI) is determined to be present with CG PUSCH of a CG configuration in which there are multiple CG PUSCH occasions in one CG period, the new CG-UCI (or a new CG-UCI field in the existing CG-UCI) may be present only in X (e.g., X=1, 2, 3) (actually transmitted) CG PUSCH occasions from the beginning (or end) or may be present in each (actually transmitted) CG PUSCH occasion.

Furthermore, in a case where new CG-UCI (or a new CG-UCI field in the existing CG-UCI) is present for all CG PUSCHs or for a specific CG PUSCH, the CG-UCI may be present periodically.

(Example 1) In a case where the presence of new CG-UCI (or a new CG-UCI field in the existing CG-UCI) is for any CG PUSCH, the new CG-UCI (or the new CG-UCI field in the existing CG-UCI) may be present periodically. In other words, the new CG-UCI (or the new CG-UCI field in the existing CG-UCI) may be present for X times in one periodicity (e.g., where X=1, for the first CG-PUSCH). The periodicity may be every Y slots/symbols/subframes/frames (or s/ms/minutes/hours/days, etc.) or every Y CG PUSCH occasions.

Note that new CG-UCI (or a new CG-UCI field in the existing CG-UCI) may be present periodically in at least one of the following cases:
Case where the CG PUSCH is a type 1 (or type 2) CG PUSCH;
Case where the CG PUSCH has a high (or low) physical priority;
Case where the CG PUSCH is repeatedly transmitted (or not transmitted);
Case where there is one (or multiple) CG PUSCH occasion(s) in one CG period of the CG configuration; and/or
Case where there is one (or multiple) CG PUSCH occasion(s) in one CG period of the CG configuration.

Furthermore, the periodicity of the presence of new CG-UCI (or a new CG-UCI field in the existing CG-UCI) may be every Y CG PUSCH occasions in at least one of the following cases:
Case where the CG PUSCH is a type 1 (or type 2) CG PUSCH;
Case where the CG PUSCH has a high (or low) physical priority;
Case where the CG PUSCH is repeatedly transmitted (or not transmitted); and/or
Case where there is one (or multiple) CG PUSCH occasion(s) in one CG period.

(Example 2) In a case where the presence of new CG-UCI (or a new CG-UCI field in the existing CG-UCI) is for a CG configuration, the new CG-UCI (or the new CG-UCI field in the existing CG-UCI) may be present periodically. In other words, the new CG-UCI (or the new CG-UCI field in the existing CG-UCI) may be present for X times in one periodicity (e.g., where X=1, for the first CG-PUSCH). The periodicity may be every Y slots/symbols/subframes/frames (or s/ms/minutes/hours/days, etc.) or every Y CG PUSCH occasions of the CG configuration.

### <Proposal 8>

In Proposal 8, specific indication contents of unused CG PUSCH occasions by a CG-UCI field is proposed.

### <Option 1>

The CG-UCI field indicates the number of consecutive unused (valid) CG PUSCH occasions (e.g., M consecutive unused (valid) CG PUSCH occasions).

Note that “invalid CG PUSCH occasions” may include at least one of the following:
CG PUSCH occasion overlapping with a symbol configured as DL by TDD-Config-Common and/or TDD-Config-Dedicated;
CG PUSCH occasion overlapping with a symbol configured for SSB reception;
CG PUSCH occasion overlapping with a type 0 CSS symbol;
CG PUSCH occasion overlapping with a CORESET #0 symbol;
CG PUSCH occasion overlapping with a symbol indicated as DL (or flexible) by DCI 2_0; and/or
CG PUSCH occasion overlapping with a DL subband (and/or guard band) in a symbols configured for SBFD operation (however, this is a duplex enhancement function in Rel-18).

The “valid CG PUSCH occasion” may mean a CG PUSCH occasion that is not an “invalid CG PUSCH occasion.”

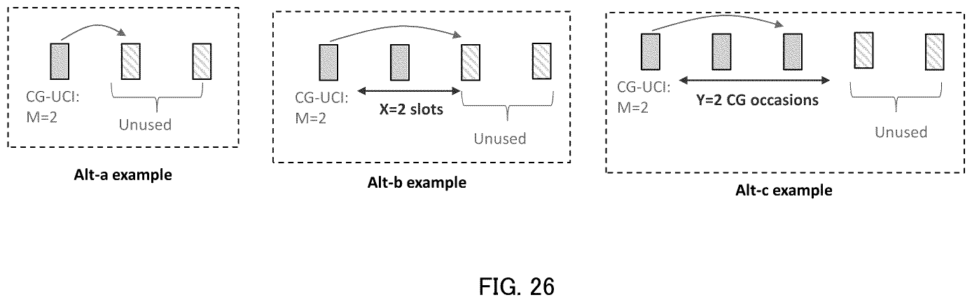

Among M consecutive unused CG PUSCH occasions, the first indicated unused CG PUSCH occasion may be one of the following:
(Alt-a) The first (valid) CG PUSCH occasion that starts after the end of the current CG PUSCH occasion (i.e., CG PUSCH that transmits CG-UCI) (see Alt-a example in FIG. 26);
(Alt-b) The first (valid) CG PUSCH occasion that starts/ends after X slots/symbols from the start/end symbol of the current CG PUSCH occasion (see Alt-b example in FIG. 26); or
(Alt-c) The first (valid) CG PUSCH occasion that starts/ends after the start/end symbol of Y CG PUSCH occasions from the current CG PUSCH occasion (see Alt-c example in FIG. 26).

The value of X in Alt-b and/or the value of Y in Alt-c may be defined by the specification, configured by the RRC configuration, or indicated by the CG-UCI field.

Furthermore, the minimum/maximum values of X and/or Y may be defined by the specification or may be separately defined for different subcarrier spacings, different frequency ranges, or the like.

The count of X slots/symbols may include or need not include at least one of the following:
Slot/symbol configured as DL by TDD-Config-Common and/or TDD-Config-Dedicated;
Slot/symbol configured for SSB reception;
Type 0 CSS symbol; and/or
CORESET #0 symbol.

Invalid CG PUSCH occasions may be considered or need not be considered in the counting of Y CG PUSCH occasions.

In counting Y CG PUSCH occasions, only the CG PUSCH occasions with the same CG configuration as the CG PUSCH transmitting CG-UCI may be counted, only the CG PUSCH occasions in the same CG period as the CG PUSCH transmitting CG-UCI may be counted, or CG PUSCH occasions with any CG configuration may be counted.

### <Variation of Option 1>

### (Variation 0)

In the above Alt-a/Alt-b/Alt-c, the first-indicated (valid) CG PUSCH occasion may be determined by considering only the (valid) CG PUSCH occasions with the same CG configuration as the CG PUSCH transmitting CG-UCI, or may be determined regardless of the CG configuration.

### (Variation 1)

The case of counting unused CG PUSCH occasions may be as follows.

### (Variation 1-1)

Only M unused CG PUSCH occasions with the same CG configuration as the CG PUSCH transmitting CG-UCI may be counted, M unused CG PUSCH occasions in the same CG period as the CG PUSCH transmitting CG-UCI may be counted, or M CG PUSCHs with any CG configuration may be counted.

### (Variation 1-2)

Invalid CG PUSCH occasions may or need not be counted for M.

### (Variation 2)

The maximum value of M may be defined by the specification, configured by RRC, or determined based on the periodicity of CG-UCI.

### (Variation 3)

In a case where the next CG PUSCH occasion is used (e.g., in the case of Alt-a), or in a case where consecutive CG PUSCH occasions within a reporting range (e.g., X/Y in Alt-b/Alt-c) are unused, the terminal may assume M=0 for the indication field, or determine new CG-UCI (or a new CG-UCI field in the existing CG-UCI) that is not present with CG PUSCH.

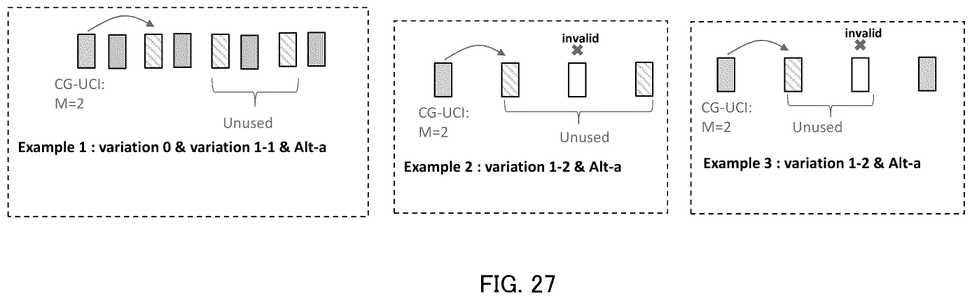

Example 1 in FIG. 27 illustrates an example of Variation 0, Variation 1-1, and Alt-a. In this case, only the CG PUSCH occasions with the same CG configuration are considered for determining the first-indicated CG PUSCH occasion and counting M.

Example 2 in FIG. 27 illustrates an example of Variation 1-2 and Alt-a. In this case, invalid CG PUSCH occasions are not counted for M.

Example 3 in FIG. 27 illustrates another example of Variation 1-2 and Alt-a. In this case, invalid CG PUSCH occasions are counted for M.

### <Option 2>

The CG-UCI field indicates whether each of the N consecutive (valid) CG PUSCH occasions is used.

Alt-a/Alt-b/Alt-c of Option 1 in Proposal 8 can be reused to determine the first-indicated unused CG PUSCH occasion among X consecutive CG PUSCH occasions.

In this case, the value of N may be defined by the specification (e.g., N=1), configured by RRC, or indicated by the CG-UCI field.

For example, when N=1, the CG-UCI field may indicate any of the following regarding whether to use the first (valid) CG PUSCH occasion.
The CG-UCI field indicates whether to use the first (valid) CG PUSCH occasion starting after the end of the current CG PUSCH occasion (i.e., CG PUSCH transmitting CG-UCI).
The CG-UCI field indicates whether to use the first (valid) CG PUSCH occasion starting/ending after X slots/symbols from the start/end symbol of the current CG PUSCH occasion. Here, the value of X may be defined by the specification, configured by the RRC configuration, or indicated by a field in CG-UCI.
The CG-UCI field indicates whether to use the first (valid) CG PUSCH occasion starting/ending after the start/end symbol of Y CG PUSCH occasions from the current CG PUSCH occasion. Here, the value of Y may be defined by the specification, configured by the RRC configuration, or indicated by a field in CG-UCI.

### <Variation of Option 2>

In the case of Alt-a/Alt-b/Alt-c, the first-indicated (valid) CG PUSCH occasion may be determined by considering only the (valid) CG PUSCH occasions with the same CG configuration as the CG PUSCH transmitting CG-UCI, or may be determined regardless of the CG configuration.

In the case of counting unused CG PUSCH occasions, only N unused CG PUSCH occasions with the same CG configuration as the CG PUSCH transmitting CG-UCI may be counted, only N unused CG PUSCH occasions in the same CG period as the CG PUSCH transmitting CG-UCI may be counted, or N CG PUSCHs of any CG configuration may be counted.

Note that invalid CG PUSCH occasions may or need not be counted for N.

The maximum value of N may be defined by the specification, configured by RRC, or determined based on the periodicity of CG-UCI.

### <Option 3>

The CG-UCI field may indicate a time window.

The association between the time window and the dynamic indication of unused CG PUSCH occasions may be any of the following.

(Example 1) All CG PUSCH occasions within the time window may be considered unused.

(Example 2) All CG PUSCH occasions with the same CG configuration (as CG PUSCHs transmitting CG-UCI) within the time window may be considered unused.

(Example 3) All CG PUSCHs with a certain CG configuration may be considered unused within the time window. In this case, the certain CG configuration may be configured by the specification (e.g., CG configuration with multiple CG PUSCH occasions in one CG period), defined by the RRC configuration (e.g., group of CG configuration indexes configured by RRC), or indicated by a field in CG-UCI.

### (Dynamic Indication of Time Window)

The start of a time window may be any of the following:
(Alt-a) The first slot/symbol after the end of the current CG PUSCH occasion (i.e., CG PUSCH transmitting CG-UCI);
(Alt-b) The first slot/symbol after X slots/symbols from the start/end symbol of the current CG PUSCH occasion; or
(Alt-c) The first slot/symbol after the start/end symbol of Y CG PUSCH occasions from the current CG PUSCH occasion.

The value of X in Alt-b and/or the value of Y in Alt-c may be defined by the specification, configured by the RRC configuration, or indicated by a field in CG-UCI.

The minimum/maximum values of X and/or Y may be defined by the specification or may be separately defined for different subcarrier spacings, different frequency ranges, or the like.

The duration of the time window may be defined by the specification, configured by the RRC indication, or indicated by a field in CG-UCI.

The following may be or need not be counted for the duration of the time window:
Slot/symbol configured as DL by TDD-Config-Common and/or TDD-Config-Dedicated;
Slot/symbol configured for SSB reception;
Type 0 CSS symbol; and
CORESET #0 symbol.

### (Variation)

The count of X slots/symbols may or need not include at least one of the following:
Slot/symbol configured as DL by TDD-Config-Common and/or TDD-Config-Dedicated;
Slot/symbol configured for SSB reception;
Type 0 CSS symbol; and/or
CORESET #0 symbol.

The count of Y CG PUSCH occasions may or need not consider invalid CG PUSCH occasions.

In counting Y CG PUSCH occasions, only the CG PUSCH occasions with the same CG configuration as the CG PUSCH transmitting CG-UCI may be counted, only the CG PUSCH occasions in the same CG period as the CG PUSCH transmitting CG-UCI may be counted, or CG PUSCH occasions of any CG configuration may be counted.

### <Variation of the Entire Embodiment>

Which of the plurality of proposals, options, and/or alternatives are applied may be determined by the following.
Configured by a parameter of a higher layer
Reported by UE as UE capability(ies)
Described in the specifications
Determined based on the configuration of a higher-layer parameter and a reported UE capability
Determined by a combination of two or more of the above determinations
Slot may be replaced with sub-slots

### <UE Capability>

UE capability indicating the capability of a UE may include the following information indicating the capability of the UE. Note that the information indicating the capability of the UE may correspond to information defining the capability of the UE.
Information defining whether the UE supports multiple consecutive CG PUSCHs in one CG periodicity
Information defining whether the UE supports multiple slot-based SPS PDSCHs in one SPS periodicity
Information defining whether the UE supports multiple consecutive SPS PDSCHs in one SPS periodicity
Information defining whether the UE supports multiple PUSCHs with an individual TDRA indication/configuration for each CG PUSCH in one CG periodicity
Information defining whether the UE supports multiple PDSCHs with an individual TDRA indication/configuration for each SPS PDSCH in one CG periodicity.
Information defining whether the UE supports the reception of actual transmissions in any PDSCH occasion of multiple SPS PDSCHs in one SPS periodicity.
Information defining whether the UE supports actual transmission in any PUSCH occasion of multiple CG PUSCHs in one CG periodicity.
Information defining whether the UE supports individual HARQ-ACK feedback determinations for different SPS PDSCHs in one SPS periodicity.
Information defining whether the UE supports the function of reporting HARQ-ACKs for different SPS PDSCHs in one SPS periodicity using one PUCCH.
Information defining whether the UE supports reporting of dynamic indication of one or more unused or unutilized CG PUSCH occasions.
Information defining whether the UE supports reporting of dynamic indication of one or more unused or unutilized CG PUSCH occasions by CG-UCI.

The essential or prerequisite features for the UE capability to report dynamic indication of one or more unused or unutilized CG PUSCH occasions may include the following:
The UE capability of multiple CG PUSCHs in one CG periodicity; and/or
The UE capability of multiple CG configurations.

The UE capability of multiple CG PUSCHs in one CG periodicity is an essential or

prerequisite UE capability for reporting dynamic indication of one or more unused CG PUSCH occasions.

The UE is assumed to simultaneously report the capability of multiple CG PUSCHs in one CG periodicity and the capability of reporting dynamic indication of one or more unused CG PUSCH occasions.

### <Example of Radio Communication System>

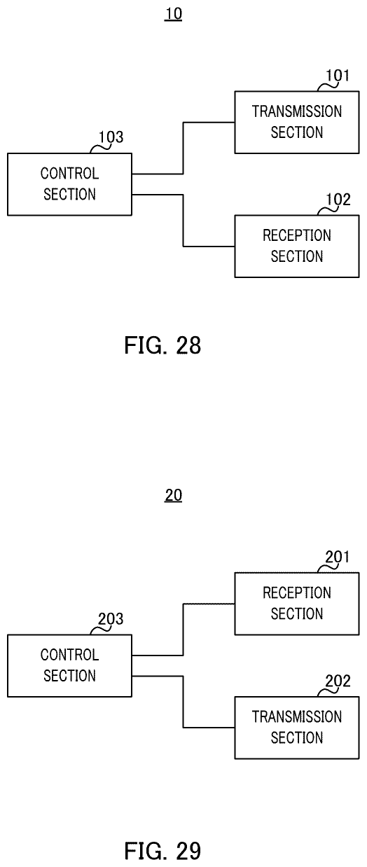

A radio communication system according to the present embodiment includes base station 10 illustrated in FIG. 28 and terminal 20 illustrated in FIG. 29. The number of base stations 10 and the number of terminals 20 are not particularly limited. For example, the system may be as illustrated in FIG. 1 in which two base stations 10 (base stations 10-1 and 10-2) communicate with one terminal 20. The radio communication system may be a radio communication system conforming to New Radio (NR). Illustratively, the radio communication system may be a radio communication system conforming to a scheme called URLLC and/or IIoT.

Note that, the radio communication system may be a radio communication system conforming to a scheme called 5G, Beyond 5G, 5G Evolution or 6G.

Base station 10 may be referred to as an NG-RAN Node, an ng-eNB, an eNodeB (eNB), or a gNodeB (gNB). Terminal 20 may be referred to as User Equipment (UE). Further, base station 10 may be regarded as an apparatus included in a network to which terminal 20 is connected.

The radio communication system may include a Next Generation-Radio Access Network (hereinafter referred to as NG-RAN). The NG-RAN includes a plurality of NG-RAN Nodes, specifically a plurality of gNBs (or ng-eNBs), and is connected to a core network (5GC, not illustrated) conforming to 5G. Note that, the NG-RAN and the 5GC may be simply represented as “network.”

Base station 10 performs radio communication with terminal 20. For example, the radio communication to be performed follows the NR. By controlling radio signals transmitted from a plurality of antenna elements, at least one of base station 10 and terminal 20 may support Massive Multiple-Input Multiple-Output (MIMO) that generates a beam (BM) having higher directivity. Further, at least one of base station 10 and terminal 20 may support carrier aggregation (CA) that aggregates and uses a plurality of component carriers (CC). Further, at least one of base station 10 and terminal 20 may support dual connectivity (DC) or the like that communicates between terminal 20 and each of a plurality of base stations 10.

The radio communication system may support a plurality of frequency bands. For example, the radio communication system supports Frequency Range (FR) 1 and FR 2.

The frequency bands of the respective FRs are, for example, as follows.
FR 1:410 MHz to 7.125 GHz
FR 2:24.25 GHz to 52.6 GHz

In FR 1, a Sub-Carrier Spacing (SCS) of 15 kHz, 30 kHz or 60 kHz may be used, and a bandwidth (BW) of 5 MHz to 100 MHz may be used. FR 2 is, for example, a higher frequency than FR 1. In FR 2, an SCS of 60 kHz or 120 kHz may be used and a bandwidth (BW) of 50 MHz to 400 MHz may be used. FR 2 may also include an SCS of 240 kHz.

The radio communication system in the present embodiment may support a higher frequency band than the frequency band of FR 2. For example, the radio communication system in the present embodiment may support a frequency band exceeding 52.6 GHz and up to 114.25 GHz. Such a high frequency band may be referred to as “FR 2x.”

Further, Cyclic Prefix-Orthogonal Frequency Division Multiplexing (CP-OFDM)/Discrete Fourier Transform-Spread-Orthogonal Frequency Division Multiplexing (DFT-S-OFDM) having a larger sub-carrier spacing (SCS) than that in the example described above may be applied. Further, the DFT-S-OFDM may be applied to both uplink and downlink or may be applied to either one of them.

In the radio communication system, a slot configuration pattern of Time Division Duplex (TDD) may be configured. For example, a pattern representing the order of two or more slots among slots for transmitting a downlink (DL) signal, slots for transmitting an uplink (UL) signal, slots in which a DL signal(s), a UL signal(s), and a guard symbol(s) are mixed, and slots in which a signal to be transmitted is flexibly changed may be defined in a slot configuration pattern.

Further, in the radio communication system, it is possible to perform PUSCH (or Physical Uplink Control Channel (PUCCH)) channel estimation by using a demodulation reference signal (DMRS) per slot, and it is further possible to perform PUSCH (or PUCCH) channel estimation by using DMRSs that are assigned to a plurality of slots, respectively. Such channel estimation may be referred to as joint channel estimation or may be referred to as another name, such as cross-slot channel estimation.

Terminal 20 may transmit DMRSs respectively assigned to a plurality of slots in the plurality of slots so that base station 10 can perform the joint channel estimation using the DMRSs.

Further, in the radio communication system, an enhanced function may be added to the function of feedback from terminal 20 to base station 10. For example, an enhanced function of feedback of the terminal for HARQ-ACKs may be added.

Next, configurations of base station 10 and terminal 20 will be described. Note that, the configurations of base station 10 and terminal 20 described below illustrate exemplary functions related to the present embodiment. Base station 10 and terminal 20 may have functions that are not illustrated. Further, the function classification and/or the name of the functional section are/is not limited as long as the functions serve for executing operations according to the present embodiment.

### <Configuration of Base Station>

FIG. 28 is a block diagram illustrating an example of a configuration of base station 10 according to the present embodiment. Base station 10 includes, for example, transmission section 101, reception section 102, and control section 103. Base station 10 communicates with terminal 20 by radio (see FIG. 29).

Transmission section 101 transmits a downlink (DL) signal to terminal 20. For example, transmission section 101 transmits the DL signal under the control of control section 103.

The DL signal may include, for example, a downlink data signal and control information (e.g., Downlink Control Information (DCI)). Further, the DL signal may include information indicating scheduling related to signal transmission of terminal 20 (e.g., UL grant). Further, the DL signal may include higher layer control information (e.g., Radio Resource Control (RRC) control information). Further, the DL signal may include a reference signal.

Channels used for DL signal transmission include, for example, data channels and control channels. For example, the data channels may include Physical Downlink Shared Channel (PDSCH) and the control channels may include Physical Downlink Control Channel (PDCCH). For example, base station 10 transmits control information to terminal 20 by using PDCCH and transmits a downlink data signal by using PDSCH.

The reference signal included in the DL signal may include, for example, at least one of a Demodulation Reference Signal (DMRS), a Phase Tracking Reference Signal (PTRS), a Channel State Information-Reference Signal (CSI-RS), a Sounding Reference Signal (SRS), and a Positioning Reference Signal (PRS) for position information. For example, the reference signal such as the DMRS and the PTRS is used for demodulating a downlink data signal and is transmitted by using PDSCH.

Reception section 102 receives an uplink (UL) signal transmitted from terminal 20. For example, reception section 102 receives the UL signal under the control of control section 103.

Control section 103 controls communication operations of base station 10 including transmission processing in transmission section 101 and reception processing in reception section 102.

For example, control section 103 acquires data and information such as control information from a higher layer, and outputs the data and information to transmission section 101. Further, control section 103 outputs the data, control information and/or the like received from reception section 102 to a higher layer.

For example, control section 103 allocates resources (or channels) used for DL signal transmission and reception and/or resources used for UL signal transmission and reception, based on a signal (e.g., data, control information and/or the like) received from terminal 20 and/or based on data, control information and/or the like acquired from a higher layer. Information on the allocated resources may be included in control information to be transmitted to terminal 20.

Control section 103 configures a PUCCH resource as an example of the allocation of resources used for UL signal transmission and reception. Information on PUCCH configuration such as a PUCCH cell timing pattern (PUCCH configuration information) may be indicated to terminal 20 by RRC.

### <Configuration of Terminal>

FIG. 29 is a block diagram illustrating an example of a configuration of terminal 20 according to the present embodiment. Terminal 20 includes, for example, reception section 201, transmission section 202, and control section 203. Terminal 20 communicates with base station 10 by radio, for example.

Reception section 201 receives a DL signal transmitted from base station 10. For example, reception section 201 receives the DL signal under the control of control section 203.

Transmission section 202 transmits a UL signal to base station 10. For example, transmission section 202 transmits the UL signal under the control of control section 203.

The UL signal may include, for example, an uplink data signal and control information (e.g., UCI). For example, the UL signal may include information on processing capabilities of terminal 20 (e.g., UE capability). Further, the UL signal may include a reference signal.

Channels used for UL signal transmission include, for example, data channels and control channels. For example, the data channels include Physical Uplink Shared Channel (PUSCH) and the control channels include Physical Uplink Control Channel (PUCCH). For example, terminal 20 receives control information from base station 10 by using PUCCH and transmits an uplink data signal by using PUSCH.

The reference signal included in the UL signal may include, for example, at least one of a DMRS, a PTRS, a CSI-RS, an SRS, and a PRS. For example, the reference signal such as the DMRS and the PTRS is used for demodulating an uplink data signal and is transmitted by using an uplink channel (e.g., PUSCH).

Control section 203 controls communication operations of terminal 20 including reception processing in reception section 201 and transmission processing in transmission section 202.

For example, control section 203 acquires data and information such as control information from a higher layer, and outputs the data and control information to transmission section 202. Further, control section 203 outputs, for example, the data, control information and/or the like received from reception section 201 to a higher layer.

For example, control section 203 controls transmission of information to be fed back to base station 10. The information to be fed back to base station 10 may include, for example, an HARQ-ACK, Channel State Information (CSI), and a Scheduling Request (SR). The information to be fed back to base station 10 may be included in UCI. The UCI is transmitted in a PUCCH resource.

Control section 203 configures a PUCCH resource based on the configuration information received from base station 10 (e.g., configuration information such as PUCCH cell timing pattern indicated by RRC and/or DCI). Control section 203 determines a PUCCH resource used for transmitting the information to be fed back to base station 10. Under the control of control section 203, transmission section 202 transmits the information to be fed back to base station 10 in the PUCCH resource determined by control section 203.

Note that, the channels used for DL signal transmission and the channels used for UL signal transmission are not limited to the examples mentioned above. For example, the channels used for DL signal transmission and the channels used for UL signal transmission may include a Random Access Channel (RACH) and a Physical Broadcast Channel (PBCH).

The RACH may be used, for example, to transmit Downlink Control Information (DCI) including a Random Access Radio Network Temporary Identifier (RA-RNTI).

Control section 203 may configure periodicity of receiving DL signals based on periodicity configuration information. Reception section 201 may receive the DL signals using multiple SPS PDSCHs per configured reception periodicity. The periodicity configuration information may be, for example, an RRC parameter.

Reception section 201 may receive the DL signals using multiple SPS PDSCHs in multiple consecutive slots, as illustrated in FIGS. 14 to 18. Reception section 201 may receive the DL signals using one SPS PDSCH included in each of multiple slots, as illustrated in FIG. 14. Reception section 201 may receive the DL signals using multiple SPS PDSCHs included in each of multiple slots, as illustrated in FIGS. 15 to 18.

The above configuration allows terminal 20 to perform SPS PDSCH communication suitable for large-capacity communication.

Reception section 201 may receive configuration information of transmission periodicity for UL signals and individual TDRAs for multiple CG PUSCHs transmitting the UL signals. Control section 203 may allocate the CG PUSCHs to resources based on the individual TDRAs per transmission periodicity of the received configuration information. The configuration information may be, for example, an RRC parameter.

Reception section 201 may receive the TDRAs using higher-layer signaling such as RRC signaling. The RRC signaling may also be referred to as an RRC message or RRC information element.

The above configuration allows terminal 20 to perform CG PUSCH communication suitable for large-capacity communication.

Control section 203 may determine the leading CG PUSCH in one slot based on the TDRA per transmission periodicity of the received configuration information and determine the following CG PUSCHs in one slot to fit within the rear boundary of the slot. For example, as illustrated in FIGS. 16 and 17, control section 203 may determine the leading CG PUSCH in one slot based on the TDRA, and determine the following CG PUSCHs in one slot to fit within the rear boundary of the slot. Control section 203 may consecutively allocate multiple CG PUSCHs to resources within one slot.

The above configuration allows terminal 20 to perform CG PUSCH communication suitable for large-capacity communication.

Reception section 201 may receive DL signals using multiple SPS PDSCHs per configured reception periodicity, and transmission section 202 may transmit response signals to the DL signals. Transmission section 202 may transmit the response signals using one PUCCH. The response signals may be, for example, HARQ-ACKs. Reception section 201 and transmission section 202 may also be referred to as communication sections.

Control section 203 may determine the number of candidate reception occasions for multiple SPS PDSCHs based on the maximum number of SPS PDSCHs in one slot. Control section 203 may determine the number of candidate reception occasions for multiple SPS PDSCHs based on the maximum number of SPS PDSCHs per reception periodicity. Control section 203 may determine a slot set of multiple SPS PDSCHs to be the target for the response signal transmission, based on the maximum number of SPS PDSCHs per reception periodicity.

The above configuration allows terminal 20 to appropriately report HARQ-ACKs for SPS PDSCHs suitable for large-capacity communication.

The present disclosure has been described above.

### <Hardware Structure>

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

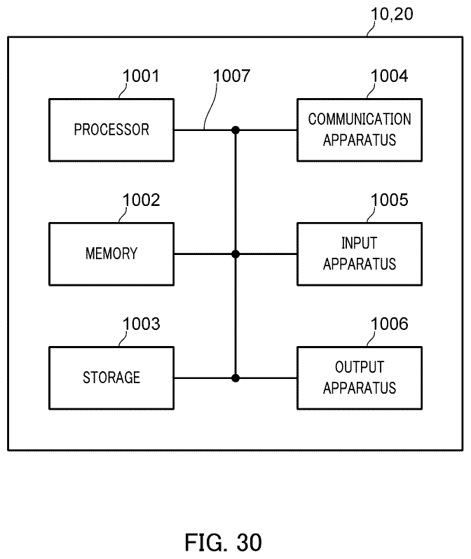

For example, a base station, a terminal, and so on according to one embodiment of the present disclosure may function as a computer that executes the processes of the radio communication method of the present disclosure. FIG. 30 is a diagram to show an example of a hardware structure of a base station and a terminal according to one embodiment of a present disclosure. Physically, the above-described base station 10 and terminal 20 may each be formed as a computer apparatus that includes processor 1001, memory 1002, storage 1003, communication apparatus 1004, input apparatus 1005, output apparatus 1006, bus 1007, and so on.

Note that in the present disclosure, the words such as an apparatus, a circuit, a device, a section, a unit, and so on can be interchangeably interpreted. The hardware structure of base station 10 and terminal 20 may be configured to include one or more of apparatuses shown in the drawings, or may be configured not to include part of apparatuses.

Each function of base station 10 and terminals 20 is implemented, for example, by allowing certain software (programs) to be read on hardware such as processor 1001 and memory 1002, and by allowing processor 1001 to perform calculations to control communication via communication apparatus 1004 and control at least one of reading and writing of data in memory 1002 and storage 1003.

Processor 1001 controls the whole computer by, for example, running an operating system. Processor 1001 may be configured with a central processing unit (CPU), which includes interfaces with peripheral apparatus, control apparatus, computing apparatus, a register, and so on. For example, at least part of above-described control section 103, control section 203, and so on may be implemented by processor 1001.

Furthermore, processor 1001 reads programs (program codes), software modules, data, and so on from at least one of storage 1003 and communication apparatus 1004, into memory 1002, and executes various processes according to these. As for the programs, programs to allow computers to execute at least part of the operations of the above-described embodiments are used. For example, control section 203 of terminal 20 may be implemented by control programs that are stored in memory 1002 and that operate on processor 1001, and other functional blocks may be implemented likewise. The various processes have been described to be performed by single processor 1001. However, the processes may be performed by two or more processors 1001 simultaneously or sequentially. Processor 1001 may be implemented by one or more chips. It should be noted that the program may be transmitted from a network via a telecommunication line.

Memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. Memory 1002 may be referred to as a “register,” a “cache,” a “main memory (primary storage apparatus)” and so on. Memory 1002 can store executable programs (program codes), software modules, and the like for implementing the radio communication method according to one embodiment of the present disclosure.

Storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. Storage 1003 may be referred to as “auxiliary storage apparatus.” The above recording medium may be a database including memory 1002 and/or storage 1003, a server, or any other appropriate medium.

Communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. Communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmission section 101, reception section 102, reception section 201, transmission section 202, and the like, may be realized by communication apparatus 1004.

Input apparatus 1005 is an input device that receives input from the outside (for example, a keyboard, a mouse, a microphone, a switch, a button, a sensor, and so on). Output apparatus 1006 is an output device that allows sending output to the outside (for example, a display, a speaker, a Light Emitting Diode (LED) lamp, and so on). Note that input apparatus 1005 and output apparatus 1006 may be provided in an integrated structure (for example, a touch panel).

Furthermore, these types of apparatus, including processor 1001, memory 1002, and others, are connected by bus 1007 for communicating information. Bus 1007 may be formed with a single bus, or may be formed with buses that vary between pieces of apparatus.

Also, base station 10 and terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Supplement to Embodiment)

While the embodiment of the present disclosure has been described above, the disclosed invention is not limited to such an embodiment, and a person skilled in the art would understand various variations, modifications, alternatives, substitutions, and the like. Specific numerical examples have been used in the description to facilitate understanding of the invention, but unless otherwise noted, these numbers are merely examples and any suitable values may be used. The division of the items in the above description is not essential to the present disclosure, and matters described in two or more items may be combined and used as necessary, and matters described in one item may be applied to matters described in another item (as long as they do not contradict each other). The boundaries of the functional sections and processing sections in the functional block diagram do not necessarily correspond to the boundaries of physical components. The operations of a plurality of functional sections may be performed physically by one component, or the operation of one functional section may be performed physically by a plurality of components. The processing procedures described in the embodiment may be performed in a different order as long as there is no contradiction. For convenience of description of the processing, the base station and the terminal have been described using functional block diagrams, but such apparatuses may be implemented in hardware, software, or a combination thereof. Software that operates on a processor included in the base station according to an embodiment of the present disclosure and software that operates on a processor included in the terminal according to an embodiment of the present disclosure may each be stored in any suitable storage medium, such as a random access memory (RAM), a flash memory, a read-only memory (ROM), an erasable programmable read-only memory (EPROM), an electrically erasable programmable read-only memory (EEPROM), a register, a hard disk (HDD), a removable disk, a CD-ROM, a database, a server, or the like.

### <Notification and Signaling of Information>

Notification of information is by no means limited to the embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

### <Application System>

The embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New Radio (NR), New radio access (NX), Future generation radio access (FX), W-CDMA (registered trademark), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

<Processing Procedure and the like>

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

### <Operation of Base Station>

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these. According to the above, a case is described in which there is a single network node other than the base station. However, a combination of multiple other network nodes may be considered (e.g., MME and S-GW).

### <Direction of Input and Output>

The information or signals described in this disclosure may be output from a higher layer (or lower layer) to a lower layer (or higher layer). The information or signals may be input or output through multiple network nodes.

### <Handling of Input and Output Information and the Like>

The input or output information may be stored in a specific location (e.g., memory) or managed using management tables. The input or output information may be overwritten, updated, or added. The information that has been output may be deleted. The information that has been input may be transmitted to another apparatus.

### <Determination Method>

A decision or a determination in an embodiment of the present invention may be realized by a value (0 or 1) represented by one bit, by a boolean value (true or false), or by comparison of numerical values (e.g., comparison with a predetermined values).

<Variations and the like of Aspects>

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### <Software>

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

### <Information and Signals>

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

### <System and Network>

As used in the present disclosure, the terms “system” and “network” are used interchangeably.

### <Names of Parameters and Channels>

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

### <Base Station>

In the present disclosure, the terms such as a “base station (BS),” a “radio base station,” a “fixed station,” a “NodeB,” an “eNB (eNodeB),” a “gNB (gNodeB),” an “access point,” a “transmission point,” a “reception point,” a “transmission/reception point,” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

### <Mobile Station>

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

### <Base Station/Mobile Station>

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be interpreted as a terminal. For example, an embodiment of the present disclosure may be applied to the structure that replaces a communication between a base station and a terminal with a communication between a plurality of terminals (for example, which may be referred to as “Device-to-Device (D2D),” “Vehicle-to-Everything (V2X),” and the like). In this case, the terminals may have the functions of the base stations described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the terminal in the present disclosure may be interpreted as base station. In this case, the base station may have the functions of terminal described above.

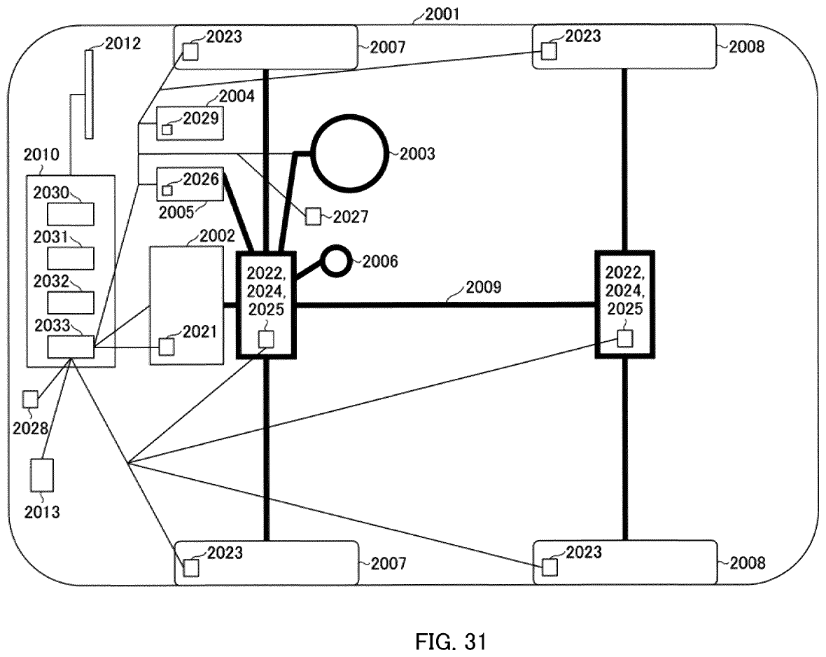

FIG. 31 shows an example of a configuration of vehicle 2001. As shown in FIG. 31, vehicle 2001 includes drive unit 2002, steering unit 2003, accelerator pedal 2004, brake pedal 2005, shift lever 2006, front wheel 2007, rear wheel 2008, axle 2009, electronic control unit 2010, various sensors 2021 to 2029, information service unit 2012, and communication module 2013. The aspects/embodiments described in the present disclosure may be applied to a communication device mounted in vehicle 2001, and may be applied to, for example, communication module 2013.

Drive unit 2002 may include, for example, an engine, a motor, and a hybrid of an engine and a motor. Steering unit 2003 includes at least a steering wheel and is configured to steer at least one of the front wheel or the rear wheel, based on the operation of the steering wheel operated by the user.

Electronic control unit 2010 includes microprocessor 2031, memory (ROM, RAM) 2032, and communication port (IO port) 2033. Electronic control unit 2010 receives signals from the various sensors 2021 to 2029 provided in vehicle 2001. Electronic control unit 2010 may be referred to as an ECU (Electronic control unit).

Signals from various sensors 2021 to 2029 include a current signal from current sensor 2021 which senses the current of the motor, a front or rear wheel rotation signal acquired by revolution sensor 2022, a front or rear wheel pneumatic signal acquired by pneumatic sensor 2023, a vehicle speed signal acquired by vehicle speed sensor 2024, an acceleration signal acquired by acceleration sensor 2025, a stepped-on accelerator pedal signal acquired by accelerator pedal sensor 2029, a stepped-on brake pedal signal acquired by brake pedal sensor 2026, an operation signal of a shift lever acquired by shift lever sensor 2027, and a detection signal, acquired by object detection sensor 2028, for detecting an obstacle, a vehicle, a pedestrian, and the like.

Information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

Information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

Driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, driving support system unit 2030 transmits and receives various types of information via communication module 2013 to realize a driving support function or an autonomous driving function.

Communication module 2013 may communicate with microprocessor 2031 and components of vehicle 2001 via a communication port. For example, communication module 2013 transmits and receives data via communication port 2033, to and from drive unit 2002, steering unit 2003, accelerator pedal 2004, brake pedal 2005, shift lever 2006, front wheel 2007, rear wheel 2008, axle 2009, microprocessor 2031 and memory (ROM, RAM) 2032 in electronic control unit 2010, and sensors 2021 to 2029 provided in vehicle 2001.

Communication module 2013 is a communication device that can be controlled by microprocessor 2031 of electronic control unit 2010 and that is capable of communicating with external devices. For example, various kinds of information are transmitted to and received from external devices through radio communication. Communication module 2013 may be internal to or external to electronic control unit 2010. The external devices may include, for example, a base station, a mobile station, or the like.

Communication module 2013 may transmit at least one of signals from various sensors 2021 to 2029 described above input to electronic control unit 2010, information obtained based on the signals, and information based on an input from the outside (a user) obtained via information service unit 2012, to the external apparatus via radio communication. Electronic control unit 2010, various sensors 2021 to 2029, information service unit 2012, and the like may be referred to as input units that receive input. For example, the PUSCH transmitted by communication module 2013 may include information based on the input.

Communication module 2013 receives various types of information (traffic information, signal information, inter-vehicle information, etc.) transmitted from the external devices and displays the received information on information service unit 2012 provided in vehicle 2001. Information service unit 2012 may be referred to as an output unit that outputs information (for example, outputs information to devices, such as a display and a speaker, based on the PDSCH received by communication module 2013 (or data/information decoded from the PDSCH)). In addition, communication module 2013 stores the various types of information received from the external devices in memory 2032 available to microprocessor 2031. Based on the information stored in memory 2032, microprocessor 2031 may control drive unit 2002, steering unit 2003, accelerator pedal 2004, brake pedal 2005, shift lever 2006, front wheel 2007, rear wheel 2008, axle 2009, sensors 2021 to 2029 etc., mounted in vehicle 2001.

### <Meaning and Interpretation of Terms>

As used herein, the term “determining” may encompasses a wide variety of actions. For example, “determining” may be regarded as judging, calculating, computing, processing, deriving, investigating, looking up or search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing, and the like. That is, “determining” may be regarded as a certain type of action related to determining. Also, “determining” may be replaced with “assuming,” “expecting,” “considering,” and the like.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

### <Reference Signal>

A reference signal may be abbreviated as an “RS,” and may be referred to as a “pilot” and so on, depending on which standard applies.

### <Meaning of “Based On”>

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

### < “First” and “Second”>

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

### <Means>

“Means” included in the configuration of each of the above apparatuses may be replaced by “parts,” “circuits,” “devices,” etc.

### <Open Form>

In the case where the terms “include,” “including” and variations thereof are used in the present disclosure, these terms are intended to be comprehensive in the same way as the term “comprising.” Further, the term “or” used in the present specification is not intended to be an “exclusive or.”

<Time Units such as TTI, Frequency Units such as RB, and Radio Frame Configuration>

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “Transmission Time Interval (TTI),” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

### <Maximum Transmit Power>

The “maximum transmit power” described in the present disclosure may mean a maximum value of the transmit power, the nominal UE maximum transmit power, or the rated UE maximum transmit power.

### <Article>

In the present disclosure, where an article is added by translation, for example “a,” “an,” and “the,” the disclosure may include that the noun following these articles is plural.

### < “Different”>

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different.”

The present patent application claims the benefit of priority based on Japanese Patent Application No. 2022-184489 filed on Nov. 17, 2022, and the entire content of Japanese Patent Application No. 2022-184489 is hereby incorporated by reference.

### INDUSTRIAL APPLICABILITY

An aspect of the present disclosure is useful for radio communication systems.

### REFERENCE SIGNS LIST

10 Base station
20 Terminal
101, 202 Transmission section
102, 201 Reception section
103, 203 Control section

1.-6. (canceled)

7. A terminal comprising:
a control section that generates UCI (Uplink Control Information) indicating whether each of multiple CG PUSCH (Physical Uplink Shared Channel) transmission occasions will be used; and
a transmit section that transmits the UCI.

8. The terminal according to claim 7, wherein:
the UCI indicates whether each of N (N is a multiple) consecutive CG PUSCH transmission occasions will be used,
wherein the value of N is set by a specific upper layer parameter.

9. The terminal according to claim 7, wherein:
the CG PUSCH transmission occasions indicated by the UCI have the same CG configuration as the CG PUSCH transmitting the UCI.

10. A system comprising:
a terminal transmitting uplink control information; and
a base station receiving the uplink control information,
wherein the terminal generates UCI (Uplink Control Information) indicating whether each of a plurality of CG PUSCH (Physical Uplink Shared Channel) transmission occasions will be used, and
the terminal transmits the UCI to the base station.

11. A communication method of a terminal, comprising:
generating UCI (Uplink Control Information) indicating whether each of a plurality of CG PUSCH (Physical Uplink Shared Channel) transmission occasions will be used, and transmitting the UCI.
